(19) United States
(12) Patent Application Publication
(10) Pub. No.: US 2023/0170995 A1
(43) Pub. Date: Jun. 1, 2023

(54) OPTICAL COMMUNICATION SYSTEM, CONTROL CIRCUIT, STORAGE MEDIUM, AND OPTICAL COMMUNICATION METHOD

(71) Applicant: Mitsubishi Electric Corporation, Tokyo (JP)

(72) Inventors: Ayano SAKAMOTO, Tokyo (JP); Kazuyuki ISHIDA, Tokyo (JP); Satoshi YOSHIMA, Tokyo (JP)

(73) Assignee: Mitsubishi Electric Corporation, Tokyo (JP)

(21) Appl. No.: 18/152,333

(22) Filed: Jan. 10, 2023

Related U.S. Application Data
(63) Continuation of application No. PCT/JP2020/032725, filed on Aug. 28, 2020.

(51) Int. Cl. H04B 10/2575; H04B 10/80

(52) U.S. Cl. CPC H04B 10/25759; H04B 10/801

(57) ABSTRACT

An optical communication system includes: a plurality of optical transmission devices converting a first data signal that is an electrical signal into an optical packet signal; an optical coupler coupling optical packet signals; an optical coupler branching the optical transmission signal generated through coupling; a plurality of optical reception devices converting the optical transmission signal generated through branching into a second data signal that is an electrical signal; and a control unit controlling operation of the optical transmission devices and the optical reception devices. The optical transmission devices allocate a communication resource to avoid collision with the optical packet signal transmitted from another optical transmission device, and transmit the optical packet signal, and the optical reception devices convert the optical transmission signal into an electrical transmission signal, select a designated signal portion from the electrical transmission signal, and output the designated signal portion as the second data signal.

### CROSS-REFERENCE TO RELATED APPLICATION

This application is a continuation application of International Application PCT/JP2020/032725, filed on Aug. 28, 2020, and designating the U.S., the entire contents of which are incorporated herein by reference.

### BACKGROUND OF THE INVENTION

### 1. Field of the Invention

The present disclosure relates to an optical communication system, a control circuit, a storage medium, and an optical communication method for transmitting signals in the optical domain.

### 2. Description of the Related Art

Some conventional optical switch devices such as the one described in International Publication No. 2017/131125 include N wavelength group generators having M fixed wavelength light sources, M branching/selecting units, and MN variable filters. The optical switch device described in International Publication No. 2017/131125 can perform M ways of path selection at the branching/selecting units and N ways of wavelength selection at the variable filters on the data input from MN input ports, thereby switching the path to a desired output port to output the data. The configuration of the optical switch device described in International Publication No. 2017/131125 is advantageous in that the optical switch device can be implemented with small-scale hardware as compared with an MN×MN-scale spatial matrix switch that uses micro electro mechanical systems (MEMS) or the like.

The branching/selecting units provided in the optical switch device described in International Publication No. 2017/131125 are implemented by a delivery and coupling (DC) switch or a multicast switch, and configured by 1×M optical couplers and M×1 optical switches. However, optical switches are active components that have a higher failure rate than passive components such as optical couplers, which is problematic in that the reliability of the entire system is reduced.

The present disclosure has been made in view of the above, and an object thereof is to obtain an optical communication system capable of improving reliability.

### SUMMARY OF THE INVENTION

In order to solve the above-described problems and achieve the object, an optical communication system according to the present disclosure includes: a plurality of optical transmission devices that each convert a first data signal that is an electrical signal into an optical packet signal, and transmit the optical packet signal; a first optical coupler that couples a plurality of the optical packet signals into an optical transmission signal, and outputs the optical transmission signal to a transmission path; a second optical coupler that branches the optical transmission signal generated through coupling by the first optical coupler and acquired via the transmission path into a plurality of the optical transmission signals having same information, and outputs the optical transmission signals; a plurality of optical reception devices that each receive one of the optical transmission signals generated through branching by the second optical coupler, converts the optical transmission signal into a second data signal that is an electrical signal, and outputs the second data signal; and a control unit that controls operation of the plurality of optical transmission devices and the plurality of optical reception devices. The optical transmission devices allocate a communication resource based on a first control signal acquired from the control unit to avoid collision with the optical packet signal transmitted from another optical transmission device, and transmit the optical packet signal. The optical reception devices convert the optical transmission signal into an electrical transmission signal, select a designated signal portion from the electrical transmission signal based on a second control signal acquired from the control unit, and output the designated signal portion as the second data signal.

### BRIEF DESCRIPTION OF THE DRAWINGS

FIG. 1 is a diagram illustrating an exemplary configuration of an optical communication system according to a first embodiment;

FIG. 2 is a diagram illustrating an example of signals transmitted in the optical communication system according to the first embodiment;

FIG. 3 is a flowchart illustrating the operation of the optical communication system according to the first embodiment;

FIG. 4 is a diagram illustrating an exemplary configuration of processing circuitry in the case that the processing circuitry provided in the optical communication system according to the first embodiment is implemented by a processor and a memory;

FIG. 5 is a diagram illustrating an example of processing circuitry in the case that the processing circuitry provided in the optical communication system according to the first embodiment is implemented by dedicated hardware;

FIG. 6 is a diagram illustrating an exemplary configuration of an optical communication system according to a second embodiment;

FIG. 7 is a diagram illustrating an example of signals transmitted in the optical communication system according to the second embodiment;

FIG. 8 is a diagram illustrating an exemplary configuration of an optical communication system according to a third embodiment;

FIG. 9 is a diagram illustrating an example of signals transmitted in the optical communication system according to the third embodiment;

FIG. 10 is a diagram illustrating an exemplary configuration of an optical communication system according to a fourth embodiment;

FIG. 11 is a diagram illustrating an example of signals transmitted in the optical communication system according to the fourth embodiment;

FIG. 12 is a diagram illustrating an exemplary configuration of an optical communication system according to a fifth embodiment;

FIG. 13 is a diagram illustrating an example of signals transmitted in the optical communication system according to the fifth embodiment;

FIG. 14 is a diagram illustrating an exemplary configuration of an optical communication system according to a sixth embodiment; and

FIG. 15 is a diagram illustrating an example of signals transmitted in the optical communication system according to the sixth embodiment.

### DETAILED DESCRIPTION OF THE PREFERRED EMBODIMENTS

Hereinafter, an optical communication system, a control circuit, a storage medium, and an optical communication method according to embodiments of the present disclosure will be described in detail with reference to the drawings.

### First Embodiment

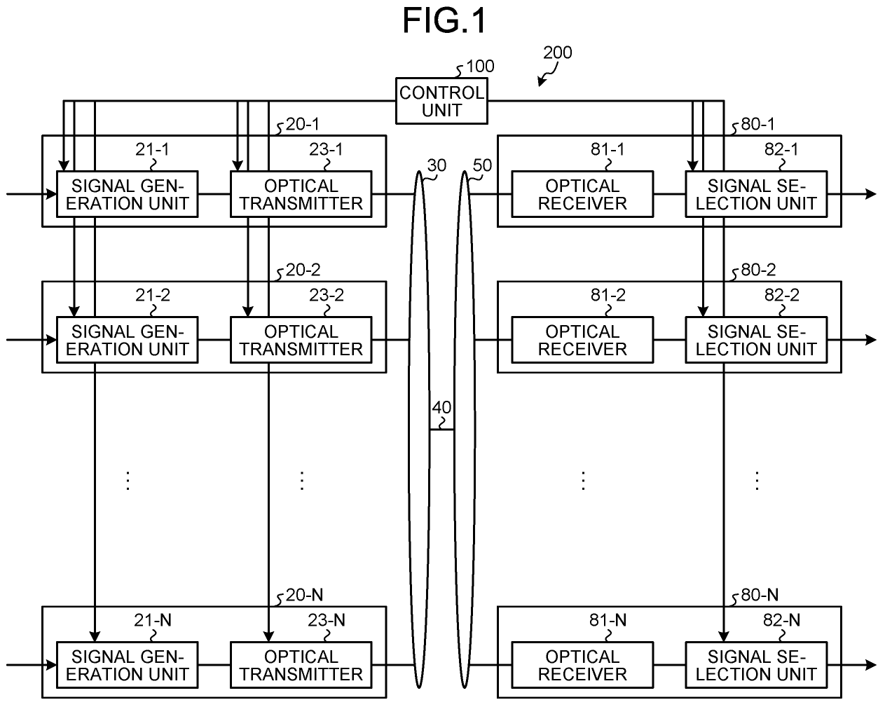

FIG. 1 is a diagram illustrating an exemplary configuration of an optical communication system 200 according to the first embodiment. The optical communication system 200 illustrated in FIG. 1 includes N input ports and N output ports (not illustrated), and performs switching between the N input ports and the N output ports in a non-blocking manner using a time-division multiplexing (TDM) method. Note that N is an integer of two or more. The optical communication system 200 includes signal generation units 21-1 to 21-N, optical transmitters 23-1 to 23-N, an optical coupler 30, a transmission path 40, an optical coupler 50, optical receivers 81-1 to 81-N, signal selection units 82-1 to 82-N, and a control unit 100.

In the optical communication system 200, the signal generation unit 21-1 and the optical transmitter 23-1 constitute an optical transmission device 20-1, the signal generation unit 21-2 and the optical transmitter 23-2 constitute an optical transmission device 20-2, and the signal generation unit 21-N and the optical transmitter 23-N constitute an optical transmission device 20-N. In addition, the optical receiver 81-1 and the signal selection unit 82-1 constitute an optical reception device 80-1, the optical receiver 81-2 and the signal selection unit 82-2 constitute an optical reception device 80-2, and the optical receiver 81-N and the signal selection unit 82-N constitute an optical reception device 80-N. The optical coupler 30 and the optical coupler 50 are, for example, power splitters. Note that the optical coupler 30 and the optical coupler 50 may be integrated with the transmission path 40 to form a configuration of N×N.

In the following description, the optical transmission devices 20-1 to 20-N may be referred to as the optical transmission device 20 when they are not distinguished, the signal generation units 21-1 to 21-N may be referred to as the signal generation unit 21 when they are not distinguished, and the optical transmitters 23-1 to 23-N may be referred to as the optical transmitter 23 when they are not distinguished. In addition, the optical reception devices 80-1 to 80-N may be referred to as the optical reception device 80 when they are not distinguished, the optical receivers 81-1 to 81-N may be referred to as the optical receiver 81 when they are not distinguished, and the signal selection units 82-1 to 82-N may be referred to as the signal selection unit 82 when they are not distinguished. In addition, the optical coupler 30 may be referred to as the first optical coupler, and the optical coupler 50 may be referred to as the second optical coupler.

The signal generation units 21-1 to 21-N acquire first data signals, i.e. electrical signals requested to be transferred, from the above-described input ports. In addition, the signal generation units 21-1 to 21-N acquire, from the control unit 100, a first control signal including a reference clock generated by the control unit 100 and a transmission timing signal, i.e. a communication resource allocation on the transmission path 40. The reference clock defines a forwarding rate for transmission/reception of optical packet signals. The communication resource allocation is determined by the control unit 100 based on a communication request for the first data signals acquired at the input ports of the optical communication system 200. The first embodiment is based on the assumption that the communication resource is time slots.

The signal generation units 21-1 to 21-N temporarily buffer the first data signals, allocate the communication resource allocation based on the transmission timing signal included in the first control signal, determine a bit rate, and generate and transmit electrical packet signals. Here, the control unit 100 controls the transmission timing signal for each signal generation unit 21 such that while an electrical packet signal is transmitted from some signal generation unit 21, no electrical packet signal is transmitted from another signal generation unit 21. In addition, the control unit 100 determines, using the reference clock, the bit rate of the electrical packet signal that is transmitted from each signal generation unit 21.

For example, in a case where all the signal generation units 21-1 to 21-N have transmission requests for electrical packet signals of the same size, the signal generation unit 21-1 transmits the electrical packet signal during time slot 1 under the control of the control unit 100, and the other signal generation units 21-2 to 21-N do not transmit the electrical packet signals during time slot 1 under the control of the control unit 100. In addition, the signal generation unit 21-2 transmits the electrical packet signal during the next time slot 2 under the control of the control unit 100, and the other signal generation units 21-1 and 21-3 to 21-N do not transmit the electrical packet signals during time slot 2 under the control of the control unit 100. The same applies hereinafter: the signal generation unit 21-N transmits the electrical packet signal during time slot N under the control of the control unit 100, and the other signal generation units 21-1 to 21-(N-1) do not transmit the electrical packet signals during time slot N under the control of the control unit 100. Note that in the absence of simultaneous signal transmission requests from the N signal generation units 21, the control unit 100 may perform control to reduce the total number of time slots in a certain time section according to the number of transmission requests. In addition, the control unit 100 may use the same width or different widths for the time slots in which the signal generation units 21-1 to 21-N transmit electrical packet signals.

In addition to the reference clock and the transmission timing signal that is the communication resource allocation described above, the control unit 100 further generates, as the first control signal, routing information indicating from which output port the first data signal acquired from a certain input port is output as the second data signal. That is, the routing information indicates which optical reception device 80 outputs as the second data signal the first data signal acquired by which optical transmission device 20. As the routing information, for example, the control unit 100 records transmission source information for each time slot indicating, for example, that data #1 is transmitted as an electrical packet signal from the signal generation unit 21-1 in time slot 1, data #2 is transmitted as an electrical packet signal from the signal generation unit 21-2 in time slot 2, and data #N is transmitted as an electrical packet signal from the signal generation unit 21-N in time slot N.

The control unit 100 distributes the reference clock, the transmission timing signal that is the communication resource allocation, and the routing information as the first control signal to the signal generation units 21-1 to 21-N and the optical transmitters 23-1 to 23-N. In addition, the control unit 100 distributes the transmission timing signal that is the communication resource allocation and the routing information as the second control signal to the signal selection units 82-1 to 82-N. Note that the control unit 100 may also distribute the first control signal to the signal selection units 82-1 to 82-N to distribute a unified type of control signal to each component, or may add different types of information to the control signals to be distributed to different components.

The signal generation units 21-1 to 21-N transmit the acquired first data signals as electrical packet signals to the corresponding optical transmitters 23-1 to 23-N at the transmission timings determined by the control unit 100. The corresponding optical transmitter 23 is the connected optical transmitter 23. For example, in the case of the signal generation unit 21-1, the corresponding optical transmitter 23 is the optical transmitter 23-1. The same applies hereinafter.

The optical transmitters 23-1 to 23-N convert the electrical packet signals acquired from the corresponding signal generation units 21-1 to 21-N into optical packet signals. The optical transmitters 23-1 to 23-N transmit the optical packet signals generated through conversion to the optical coupler 30. Note that in the example of FIG. 1, the signal generation unit 21 and the optical transmitter 23 are illustrated as separate blocks in the optical transmission device 20. However, the function of the signal generation unit 21 may be incorporated in the optical transmitter 23.

The optical coupler 30 couples the plurality of optical packet signals acquired from the optical transmitters 23-1 to 23-N. The optical coupler 30 outputs the optical transmission signal generated by coupling the plurality of optical packet signals to the optical coupler 50 via the transmission path 40 which is an optical fiber.

The optical coupler 50 branches the optical transmission signal acquired via the transmission path 40 into a plurality of optical transmission signals. The optical coupler 50 outputs the optical transmission signals generated through branching to the optical receivers 81-1 to 81-N.

The optical receivers 81-1 to 81-N convert the optical transmission signals received from the optical coupler 50 into electrical transmission signals. The optical receivers 81-1 to 81-N output the electrical transmission signals generated through conversion to the corresponding signal selection units 82-1 to 82-N.

The signal selection units 82-1 to 82-N select signals of designated time slots from the electrical transmission signals acquired from the corresponding optical receivers 81-1 to 81-N based on the routing information included in the second control signal acquired from the control unit 100. The signal selection units 82-1 to 82-N output the signals of the selected time slots as second data signals which are electrical signals. Consequently, the optical communication system 200 can switch between the N input ports and the N output ports using the TDM method.

Note that the optical communication system 200 may transfer the second data signals selected by the signal selection units 82-1 to 82-N to a subsequent-stage component, in which case the second data signals may be transferred as intermittent packet signals, or may be transferred after being converted into continuous signals at a reduced bit rate.

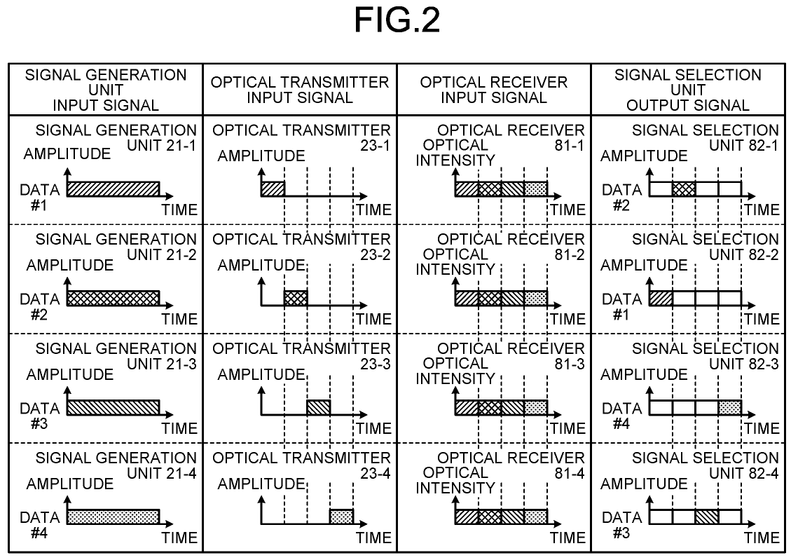

FIG. 2 is a diagram illustrating an example of signals transmitted in the optical communication system 200 according to the first embodiment. FIG. 2 also depicts the procedure for the operation of the optical communication system 200 according to the first embodiment. FIG. 2 illustrates, as an example in the case of N=4, first data signals that are input signals to the signal generation units 21-1 to 21-4, packets as electrical signals that are input signals to the optical transmitters 23-1 to 23-4, optical transmission signals that are input signals to the optical receivers 81-1 to 81-4, and second data signals that are output signals from the signal selection units 82-1 to 82-4. As illustrated in FIG. 2, the first data signal of data #1 is input to the signal generation unit 21-1, the first data signal of data #2 is input to the signal generation unit 21-2, the first data signal of data #3 is input to the signal generation unit 21-3, and the first data signal of data #4 is input to the signal generation unit 21-4.

The signal generation units 21-1 to 21-4 equalize the bit rates of the electrical packet signals to be output from the respective signal generation units 21 based on the reference clock included in the first control signal acquired from the control unit 100. In addition, the signal generation units 21-1 to 21-4 determine the transmission timings of the electrical packet signals based on the transmission timing signal included in the first control signal acquired from the control unit 100.

Specifically, in a case where all the signal generation units 21-1 to 21-4 have transmission requests for packet signals of the same size as in FIG. 2, the signal generation unit 21-1 transmits the electrical packet signal, and the signal generation units 21-2 to 21-4 do not transmit the electrical packet signals during the first time slot 1. During the second time slot 2, the signal generation unit 21-2 transmits the electrical packet signal, and the signal generation units 21-1, 21-3, and 21-4 do not transmit the electrical packet signals. During the third time slot 3, the signal generation unit 21-3 transmits the electrical packet signal, and the signal generation units 21-1, 21-2, and 21-4 do not transmit the electrical packet signals. During the fourth time slot 4, the signal generation unit 21-4 transmits the electrical packet signal, and the signal generation units 21-1 to 21-3 do not transmit the electrical packet signals. In this manner, the signal generation units 21-1 to 21-4 adjust the transmission timings of the electrical packet signals based on the transmission timing signal included in the first control signal acquired from the control unit 100.

The optical transmitters 23-1 to 23-4 convert the electrical packet signals transmitted at the determined transmission timings by the signal generation units 21-1 to 21-4 into optical packet signals. The optical coupler 30 couples the optical packet signals transmitted from the optical transmitters 23-1 to 23-4, and outputs the resultant signal as an optical transmission signal to the optical coupler 50 via the transmission path 40. The optical coupler 50 branches the optical transmission signal acquired via the transmission path 40, and outputs the resultant signals to the optical receivers 81-1 to 81-4. As illustrated in FIG. 2, the optical transmission signals received by the optical receivers 81-1 to 81-4 from the optical coupler 50 are all the same.

The optical receivers 81-1 to 81-4 convert the received optical transmission signals into electrical transmission signals, and output the electrical transmission signals to the corresponding signal selection units 82-1 to 82-4. The signal selection units 82-1 to 82-4 select signals of designated time slots from the received electrical packet signals based on the routing information included in the second control signal acquired from the control unit 100, and output the signals of the selected time slots as second data signals which are electrical signals.

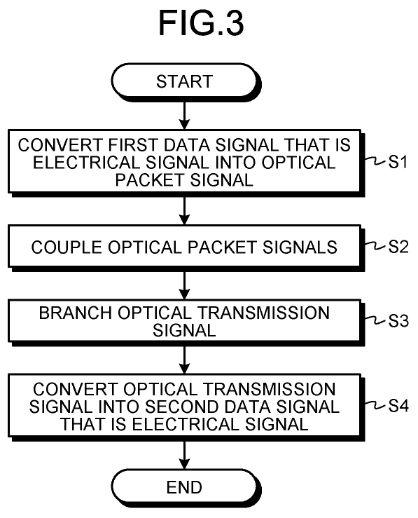

The operation of the optical communication system 200 will be described with reference to a flowchart. FIG. 3 is a flowchart illustrating the operation of the optical communication system 200 according to the first embodiment. Based on the control of the control unit 100, the optical transmission devices 20-1 to 20-N each convert the first data signal that is an electrical signal into an optical packet signal, and transmit the optical packet signal (step S1). At this time, each optical transmission device 20 allocates the communication resource based on the first control signal acquired from the control unit 100 to avoid collision with the optical packet signal transmitted from another optical transmission device 20, and transmits the optical packet signal. The optical coupler 30 couples the plurality of optical packet signals received from the optical transmission devices 20-1 to 20-N into an optical transmission signal, and outputs the optical transmission signal to the transmission path 40 (step S2). The optical coupler 50 branches the optical transmission signal generated through coupling by the optical coupler 30 and acquired via the transmission path 40 into a plurality of optical transmission signals having the same information, and outputs the optical transmission signals (step S3). Based on the control of the control unit 100, the optical reception devices 80-1 to 80-N each receive the optical transmission signal generated through branching by the optical coupler 50, convert the optical transmission signal into a second data signal that is an electrical signal, and output the second data signal (step S4). At this time, each optical reception device 80 converts the optical transmission signal into an electrical transmission signal, selects a designated signal portion from the electrical transmission signal based on the second control signal acquired from the control unit 100, and outputs the designated signal portion as a second data signal. In the optical communication system 200, the control unit 100 controls the operation of the optical transmission devices 20-1 to 20-N and the optical reception devices 80-1 to 80-N.

In the present embodiment, specifically, the optical transmission devices 20-1 to 20-N allocate time slots based on the first control signal to avoid collision with the optical packet signal transmitted from another optical transmission device 20, and transmit the optical packet signals. In addition, the optical reception devices 80-1 to 80-N select signals of designated time slots from the electrical transmission signals based on the second control signal, and output the signals as second data signals.

Next, a hardware configuration of the optical communication system 200 will be described. In the optical communication system 200, the optical transmitter 23 and the optical receiver 81 are photoelectric conversion circuits. The optical coupler 30 and the optical coupler 50 are power splitters as described above. The transmission path 40 is an optical fiber as described above. The signal generation unit 21, the signal selection unit 82, and the control unit 100 are implemented by processing circuitry. The processing circuitry may be a memory and a processor that executes a program stored in the memory, or may be dedicated hardware. The processing circuitry is also called a control circuit.

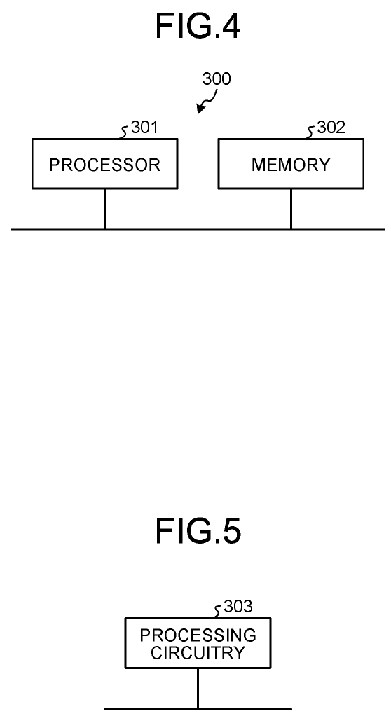

FIG. 4 is a diagram illustrating an exemplary configuration of processing circuitry 300 in the case that the processing circuitry provided in the optical communication system 200 according to the first embodiment is implemented by a processor and a memory. The processing circuitry 300 illustrated in FIG. 4 is a control circuit, and includes a processor 301 and a memory 302. In a case where the processing circuitry 300 is configured by the processor 301 and the memory 302, each function of the processing circuitry 300 is implemented by software, firmware, or a combination of software and firmware. Software or firmware is described as a program and stored in the memory 302. In the processing circuitry 300, the processor 301 reads and executes a program stored in the memory 302 to implement each function. That is, the processing circuitry 300 includes the memory 302 for storing a program that results in the execution of processing of the optical communication system 200. It can also be said that this program is a program for causing the optical communication system 200 to execute each function implemented by the processing circuitry 300. This program may be provided by a storage medium in which the program is stored, or may be provided by other means such as a communication medium.

It can also be said that the above program is a program in which the control unit 100 causes the optical transmission device 20 to allocate the communication resource based on the first control signal acquired from the control unit 100 to avoid collision with the optical packet signal transmitted from another optical transmission device 20, and transmit the optical packet signal, and causes the optical reception device 80 to convert the optical transmission signal into an electrical transmission signal, then select a designated signal portion from the electrical transmission signal based on the second control signal acquired from the control unit 100, and output the designated signal portion as a second data signal.

Here, the processor 301 is, for example, a central processing unit (CPU), a processing device, an arithmetic device, a microprocessor, a microcomputer, a digital signal processor (DSP), or the like. Here, examples of the memory 302 include a non-volatile or volatile semiconductor memory, a magnetic disk, a flexible disk, an optical disc, a compact disc, a mini disc, a digital versatile disc (DVD), and the like. Examples of the non-volatile or volatile semiconductor memory include a random access memory (RAM), a read only memory (ROM), a flash memory, an erasable programmable ROM (EPROM), an electrically EPROM (EEPROM, registered trademark), and the like.

FIG. 5 is a diagram illustrating an example of processing circuitry 303 in the case that the processing circuitry provided in the optical communication system 200 according to the first embodiment is implemented by dedicated hardware. For example, the processing circuitry 303 illustrated in FIG. 5 is a single circuit, a composite circuit, a programmed processor, a parallel programmed processor, an application specific integrated circuit (ASIC), a field-programmable gate array (FPGA), or a combination thereof. A part of the processing circuitry may be implemented by dedicated hardware, and the other part may be implemented by software or firmware. In this manner, the processing circuitry can implement each of the above-described functions by means of dedicated hardware, software, firmware, or a combination thereof.

As described above, according to the present embodiment, the optical communication system 200 controls the transmission timing for the signal generation unit 21 of each optical transmission device 20 using the TDM method, so that the matrix switch connection can be configured just with the passive components, namely the optical couplers 30 and 50, without using an optical switch in the optical domain, which can improve the reliability.

An example of an optical switch is a Mach-Zehnder interferometer, which is large in power consumption per switch port, cost, size, and weight compared with an electrical switch including an ASIC or the like, and requires a long switching time, e.g. several 10 us, from the determination of path switching information to the switching. On the other hand, the optical communication system 200, which does not use an optical switch, can achieve low power consumption, space saving, weight reduction, cost reduction, and path switching time reduction.

### Second Embodiment

In the second embodiment, the optical communication system 200 divides N first data signals acquired from N input ports into NK first data signals, transmits the NK first data signals, and outputs N second data signals from N output ports. Note that K is an integer of two or more. Differences from the first embodiment will be described.

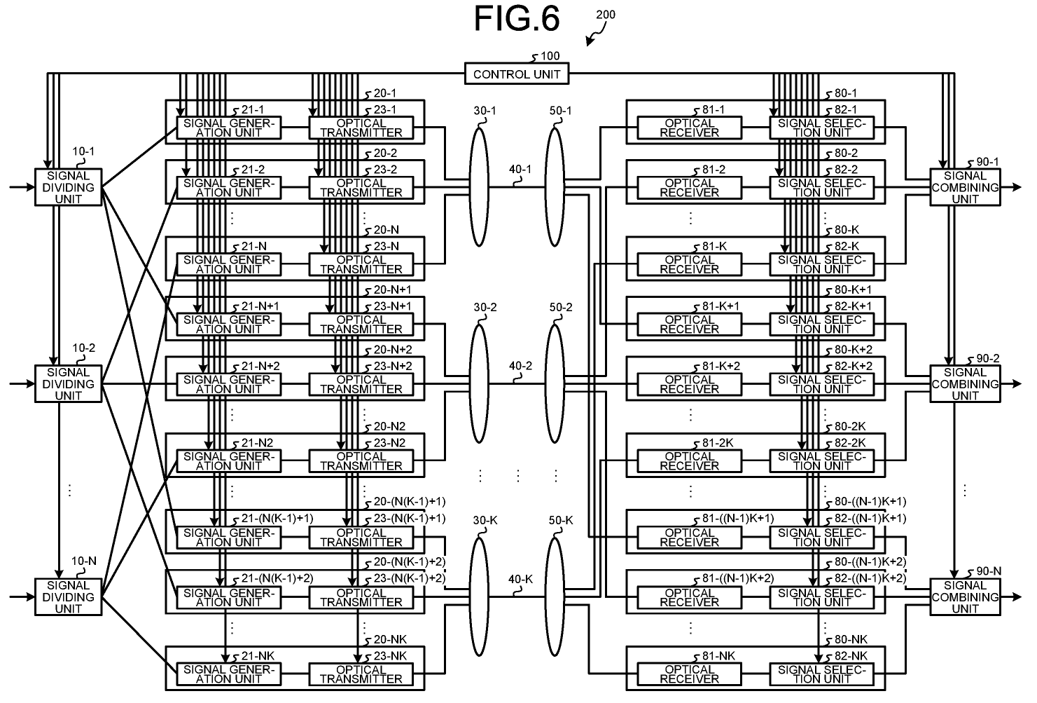

FIG. 6 is a diagram illustrating an exemplary configuration of the optical communication system 200 according to the second embodiment. The optical communication system 200 illustrated in FIG. 6 includes N input ports and N output ports (not illustrated), and performs switching between the N input ports and the N output ports using the TDM method. The optical communication system 200 includes signal dividing units 10-1 to 10-N, signal generation units 21-1 to 21-NK, optical transmitters 23-1 to 23-NK, optical couplers 30-1 to 30-K, transmission paths 40-1 to 40-K, optical couplers 50-1 to 50-K, optical receivers 81-1 to 81-NK, signal selection units 82-1 to 82-NK, signal combining units 90-1 to 90-N, and the control unit 100.

In the optical communication system 200, the signal generation unit 21-1 and the optical transmitter 23-1 constitute the optical transmission device 20-1, the signal generation unit 21-2 and the optical transmitter 23-2 constitute the optical transmission device 20-2, and the signal generation unit 21-NK and the optical transmitter 23-NK constitute an optical transmission device 20-NK. In addition, the optical receiver 81-1 and the signal selection unit 82-1 constitute the optical reception device 80-1, the optical receiver 81-2 and the signal selection unit 82-2 constitute the optical reception device 80-2, and the optical receiver 81-NK and the signal selection unit 82-NK constitute an optical reception device 80-NK. The optical couplers 30-1 to 30-K and the optical couplers 50-1 to 50-K are, for example, power splitters. Note that the optical coupler 30-1 and the optical coupler 50-1 may be paired and integrated with the transmission path 40-1 to form a configuration of N×N, the optical coupler 30-2 and the optical coupler 50-2 may be paired and integrated with the transmission path 40-2 to form a configuration of N×N, and the optical coupler 30-K and the optical coupler 50-K may be paired and integrated with the transmission path 40-K to form a configuration of N×N.

In the following description, the signal dividing units 10-1 to 10-N may be referred to as the signal dividing unit 10 when they are not distinguished, the optical transmission devices 20-1 to 20-NK may be referred to as the optical transmission device 20 when they are not distinguished, the signal generation units 21-1 to 21-NK may be referred to as the signal generation unit 21 when they are not distinguished, and the optical transmitters 23-1 to 23-NK may be referred to as the optical transmitter 23 when they are not distinguished. In addition, the optical couplers 30-1 to 30-K may be referred to as the optical coupler 30 when they are not distinguished, the transmission paths 40-1 to 40-K may be referred to as the transmission path 40 when they are not distinguished, and the optical couplers 50-1 to 50-K may be referred to as the optical coupler 50 when they are not distinguished. In addition, the optical reception devices 80-1 to 80-NK may be referred to as the optical reception device 80 when they are not distinguished, the optical receivers 81-1 to 81-NK may be referred to as the optical receiver 81 when they are not distinguished, the signal selection units 82-1 to 82-NK may be referred to as the signal selection unit 82 when they are not distinguished, and the signal combining units 90-1 to 90-N may be referred to as the signal combining unit 90 when they are not distinguished. In addition, the optical coupler 30 may be referred to as the first optical coupler, and the optical coupler 50 may be referred to as the second optical coupler.

The signal dividing units 10-1 to 10-N acquire first data signals, i.e. electrical signals requested to be transferred, from the above-described input ports. In addition, the signal dividing units 10-1 to 10-N acquire first control information from the control unit 100. Note that the signal dividing units 10-1 to 10-N may acquire only the routing information in the first control information from the control unit 100. Each of the signal dividing units 10-1 to 10-N divides the first data signal based on the routing information or the routing information included in the first control signal, and outputs the resultant signals to two or more optical transmission devices 20 connected to different optical couplers 30. For example, the signal dividing unit 10-1 divides the acquired first data signal into K based on the routing information, outputs the first ⅟K of the first data signal to the signal generation unit 21-1 of the optical transmission device 20-1, outputs the second ⅟K of the first data signal to the signal generation unit 21-N+1 of the optical transmission device 20-N+1, and outputs the K-th ⅟K of the first data signal to the signal generation unit 21-(N(K-1)+1) of the optical transmission device 20-(N(K-1)+1) .

The signal generation units 21-1 to 21-NK acquire K divisions of first data signals from the signal dividing units 10-1 to 10-N. In addition, the signal generation units 21-1 to 21-NK acquire the first control signal from the control unit 100. The signal generation units 21-1 to 21-NK temporarily buffer the first data signals, allocate the communication resource allocation based on the transmission timing signal included in the first control signal, determine a bit rate, and generate and transmit electrical packet signals. The second embodiment is based on the assumption that the communication resource is time slots. Here, the control unit 100 controls the transmission timing signal for each signal generation unit 21 such that while an electrical packet signal is transmitted from the signal generation unit 21 of some optical transmission device 20, no electrical packet signal is transmitted from the signal generation unit 21 of another optical transmission device 20 connected to the same optical coupler 30. In addition, the control unit 100 determines, using the reference clock, the bit rate of the electrical packet signal that is transmitted from each signal generation unit 21.

For example, in a case where all the signal generation units 21-1 to 21-NK have transmission requests for electrical packet signals of the same size, the signal generation units 21-1, 21-N+1,..., and 21-(N(K-1)+1) transmit the electrical packet signals during time slot 1 under the control of the control unit 100, and the other signal generation units 21 do not transmit the electrical packet signals during time slot 1 under the control of the control unit 100. In addition, the signal generation units 21-2, 21-N+2,..., and 21-(N(K-1)+2) transmit the electrical packet signals during the next time slot 2 under the control of the control unit 100, and the other signal generation units 21 do not transmit the electrical packet signals during time slot 2 under the control of the control unit 100. The same applies hereinafter: the signal generation units 21-N, 21-N2,..., and 21-NK transmit the electrical packet signals during time slot N under the control of the control unit 100, and the other signal generation units 21 do not transmit the electrical packet signals during time slot N under the control of the control unit 100. Note that in the absence of simultaneous signal transmission requests from the NK signal generation units 21, the control unit 100 may perform control to reduce the total number of time slots in a certain time section according to the number of transmission requests. In addition, the control unit 100 may use the same width or different widths for the time slots in which the signal generation units 21-1 to 21-NK transmit electrical packet signals.

The control unit 100 distributes the reference clock, the transmission timing signal that is the communication resource allocation, and the routing information as the first control signal to the signal dividing units 10-1 to 10-N, the signal generation units 21-1 to 21-NK, and the optical transmitters 23-1 to 23-NK. In addition, the control unit 100 distributes the transmission timing signal that is the communication resource allocation and the routing information as the second control signal to the signal selection units 82-1 to 82-NK and the signal combining units 90-1 to 90-N. Note that the control unit 100 may also distribute the first control signal to the signal selection units 82-1 to 82-NK and the signal combining units 90-1 to 90-N to distribute a unified type of control signal to each component, or may add different types of information to the control signals to be distributed to different components.

The signal generation units 21-1 to 21-NK transmit the first data signals as electrical packet signals to the corresponding optical transmitters 23-1 to 23-NK at the transmission timings determined by the control unit 100.

The optical transmitters 23-1 to 23-NK convert the electrical packet signals acquired from the corresponding signal generation units 21-1 to 21-NK into optical packet signals. The optical transmitters 23-1 to 23-NK transmit the optical packet signals generated through conversion to the optical couplers 30-1 to 30-K. Specifically, the optical transmitters 23-1 to 23-N transmit the optical packet signals generated through conversion to the optical coupler 30-1, the optical transmitters 23-N+1 to 23-N2 transmit the optical packet signals generated through conversion to the optical coupler 30-2, and the optical transmitters 23-(N(K-1)+1) to 23-NK transmit the optical packet signals generated through conversion to the optical coupler 30-K. Note that in the example of FIG. 6, the signal generation unit 21 and the optical transmitter 23 are illustrated as separate blocks in the optical transmission device 20. However, the function of the signal generation unit 21 may be incorporated in the optical transmitter 23.

The optical couplers 30-1 to 30-K couple the plurality of optical packet signals acquired from the optical transmitters 23-1 to 23-NK. The optical couplers 30-1 to 30-K output the optical transmission signals generated by coupling the plurality of optical packet signals to the optical couplers 50-1 to 50-K via the transmission paths 40-1 to 40-K which are optical fibers. Specifically, the optical coupler 30-1 couples the plurality of optical packet signals acquired from the optical transmitters 23-1 to 23-N, and outputs the resultant signal to the optical coupler 50-1 via the transmission path 40-1. In addition, the optical coupler 30-2 couples the plurality of optical packet signals acquired from the optical transmitters 23-N+1 to 23-N2, and outputs the resultant signal to the optical coupler 50-2 via the transmission path 40-2. The same applies hereinafter: the optical coupler 30-K couples the plurality of optical packet signals acquired from the optical transmitters 23-(N(K-1)+1) to 23-NK, and outputs the resultant signal to the optical coupler 50-K via the transmission path 40-K.

The optical couplers 50-1 to 50-K branch the optical transmission signals acquired via the transmission paths 40-1 to 40-K into a plurality of optical transmission signals. The optical couplers 50-1 to 50-K output the optical transmission signals generated through branching to the optical receivers 81-1 to 81-NK. Specifically, the optical coupler 50-1 branches the optical transmission signal acquired via the transmission path 40-1 into a plurality of optical transmission signals, and outputs the optical transmission signals to the optical receivers 81-1, 81-K+1,..., and 81-((N-1)K+1). In addition, the optical coupler 50-2 branches the optical transmission signal acquired via the transmission path 40-2 into a plurality of optical transmission signals, and outputs the optical transmission signals to the optical receivers 81-2, 81-K+2,..., and 81-((N-1)K+2). The same applies hereinafter: the optical coupler 50-K branches the optical transmission signal acquired via the transmission path 40-K into a plurality of optical transmission signals, and outputs the optical transmission signals to the optical receivers 81-K, 81-2K,..., and 81-NK.

The optical receivers 81-1 to 81-NK convert the optical transmission signals received from the optical couplers 50-1 to 50-K into electrical transmission signals. The optical receivers 81-1 to 81-NK output the electrical transmission signals generated through conversion to the corresponding signal selection units 82-1 to 82-NK.

The signal selection units 82-1 to 82-NK select signals of designated time slots from the electrical transmission signals acquired from the corresponding optical receivers 81-1 to 81-NK based on the routing information included in the second control signal acquired from the control unit 100. At this time, among the signal selection units 82-1 to 82-NK, the signal selection units 82 connected to the same signal combining unit 90 select the same type of data based on the routing information. The signal selection units 82-1 to 82-NK output the signals of the selected time slots to the signal combining units 90-1 to 90-N as second data signals which are electrical signals.

Each of the signal combining units 90-1 to 90-N combines the second data signals output from two or more optical reception devices 80 connected to different optical couplers 50 based on the routing information included in the second control signal. Consequently, the optical communication system 200 can switch between the N input ports and the N output ports using the TDM method.

In the optical communication system 200, the signal selection unit 82 of the optical reception device 80 may perform time slot switching so that the second data signals selected by the signal selection units 82 connected to the same signal combining unit 90 are not in the same slot, or the signal generation unit 21 of the optical transmission device 20 may adjust the transmission timing so that the time slots of the first data signals of the same type do not overlap.

Note that the optical communication system 200 may transfer the second data signals generated through combining by the signal combining units 90-1 to 90-N to a subsequent-stage component, in which case the second data signals may be transferred as intermittent packet signals, or may be transferred after being converted into continuous signals at a reduced bit rate.

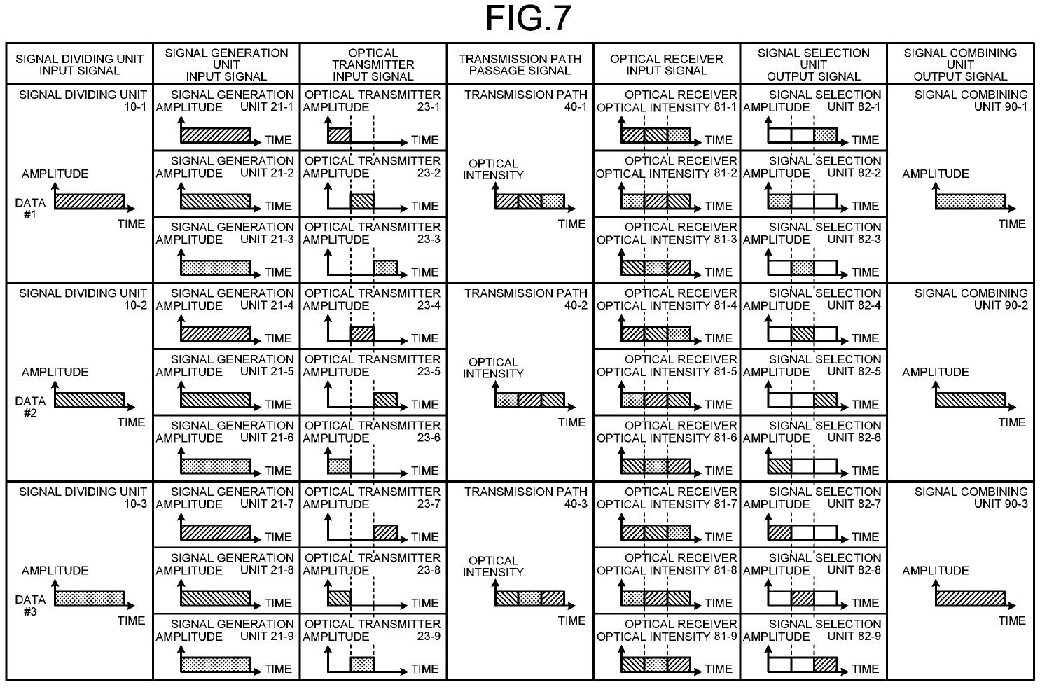

FIG. 7 is a diagram illustrating an example of signals transmitted in the optical communication system 200 according to the second embodiment. FIG. 7 also depicts the procedure for the operation of the optical communication system 200 according to the second embodiment. FIG. 7 illustrates, as an example in the case of N=3 and K=3, first data signals that are input signals to the signal dividing units 10-1 to 10-3, divided first data signals that are input signals to the signal generation units 21-1 to 21-9, packets as electrical signals that are input signals to the optical transmitters 23-1 to 23-9, optical transmission signals that are passage signals through the transmission paths 40-1 to 40-3, optical transmission signals that are input signals to the optical receivers 81-1 to 81-9, second data signals that are output signals from the signal selection units 82-1 to 82-9, and combined second data signals that are output signals from the signal combining units 90-1 to 90-3. As illustrated in FIG. 7, the first data signal of data #1 is input to the signal dividing unit 10-1, the first data signal of data #2 is input to the signal dividing unit 10-2, and the first data signal of data #3 is input to the signal dividing unit 10-3. The signal dividing units 10-1 to 10-3 divide the input first data signals into three. For example, the signal dividing unit 10-1 outputs the first one-third of the first data signal of data #1 to the signal generation unit 21-1, outputs the second one-third of the first data signal of data #1 to the signal generation unit 21-2, and outputs the third one-third of the first data signal of data #1 to the signal generation unit 21-3.

The signal generation units 21-1 to 21-9 equalize the bit rates of the electrical packet signals to be output from the respective signal generation units 21 based on the reference clock included in the first control signal acquired from the control unit 100. In addition, based on the transmission timing signal included in the first control signal acquired from the control unit 100, the signal generation units 21-1 to 21-9 determine the transmission timings of the electrical packet signals such that the signal generation units 21 of the optical transmission devices 20 connected to the same optical coupler 30 do not transmit the electrical packet signals in the same time slot.

Specifically, in a case where all the signal generation units 21-1 to 21-9 have transmission requests for packet signals of the same size as in FIG. 7, the signal generation units 21-1, 21-6, and 21-8 transmit the electrical packet signals, and the other signal generation units 21 do not transmit the electrical packet signals during the first time slot 1. During the second time slot 2, the signal generation units 21-2, 21-4, and 21-9 transmit the electrical packet signals, and the other signal generation units 21 do not transmit the electrical packet signals. During the third time slot 3, the signal generation units 21-3, 21-5, and 21-7 transmit the electrical packet signals, and the other signal generation units 21 do not transmit the electrical packet signals. In this manner, the signal generation units 21-1 to 21-9 adjust the transmission timings of the electrical packet signals based on the transmission timing signal included in the first control signal acquired from the control unit 100.

The optical transmitters 23-1 to 23-9 convert the electrical packet signals transmitted at the determined transmission timings by the signal generation units 21-1 to 21-9 into optical packet signals. The optical couplers 30-1 to 30-3 couple the optical packet signals transmitted from the optical transmitters 23-1 to 23-9, and output the resultant signals as optical transmission signals to the optical couplers 50-1 to 50-3 via the transmission paths 40-1 to 40-3. The optical couplers 50-1 to 50-3 branch the optical transmission signals acquired via the transmission paths 40-1 to 40-3, and output the resultant signals to the optical receivers 81-1 to 81-9. As illustrated in FIG. 7, the optical transmission signals received by the optical receivers 81-1, 81-4, and 81-7 from the optical coupler 50-1 are the same, the optical transmission signals received by the optical receivers 81-2, 81-5, and 81-8 from the optical coupler 50-2 are the same, and the optical transmission signals received by the optical receivers 81-3, 81-6, and 81-9 from the optical coupler 50-3 are the same.

The optical receivers 81-1 to 81-9 convert the received optical transmission signals into electrical transmission signals, and output the electrical transmission signals to the corresponding signal selection units 82-1 to 82-9. The signal selection units 82-1 to 82-9 select signals of designated time slots from the received electrical packet signals based on the routing information included in the second control signal acquired from the control unit 100, and output the signals of the selected time slots as second data signals which are electrical signals. The signal combining units 90-1 to 90-3 combine the second data signals output from the signal selection units 82-1 to 82-9, and output the resultant signals.

As described above, in the present embodiment, the optical transmission devices 20-1 to 20-NK acquire the first data signals from the signal dividing units 10-1 to 10-N, allocate time slots based on the first control signal to avoid collision with the optical packet signal transmitted from another optical transmission device 20 connected to the same optical coupler 30, and transmit the optical packet signals. In addition, the optical reception devices 80-1 to 80-NK select signals of designated time slots from the electrical transmission signals based on the second control signal, and output the signals as second data signals to the signal combining units 90-1 to 90-N.

A hardware configuration of the optical communication system 200 will be described. In the optical communication system 200, the signal dividing units 10-1 to 10-N and the signal combining units 90-1 to 90-N are implemented by processing circuitry. The processing circuitry may be a memory and a processor that executes a program stored in the memory, or may be dedicated hardware.

As described above, according to the present embodiment, the optical communication system 200 controls the transmission timing for the signal generation unit 21 of each optical transmission device 20 using the TDM method, so that the matrix switch connection can be configured just with the passive components, namely the optical couplers 30 and 50, without using an optical switch in the optical domain, which can improve the reliability. In addition, the optical communication system 200, which does not use an optical switch, can achieve low power consumption, space saving, weight reduction, cost reduction, and path switching time reduction.

In addition, the optical communication system 200 according to the second embodiment has a larger number of transmission paths 40 than the optical communication system 200 according to the first embodiment, and thus can perform transmission and reception at a low bit rate and reduce the load of system processing.

### Third Embodiment

In the third embodiment, the optical communication system 200 performs switching on MN first data signals acquired from MN input ports using the TDM method and a wavelength-division multiplexing (WDM) method, and outputs MN second data signals from MN output ports. Note that M is an integer of two or more. Differences from the first embodiment will be described.

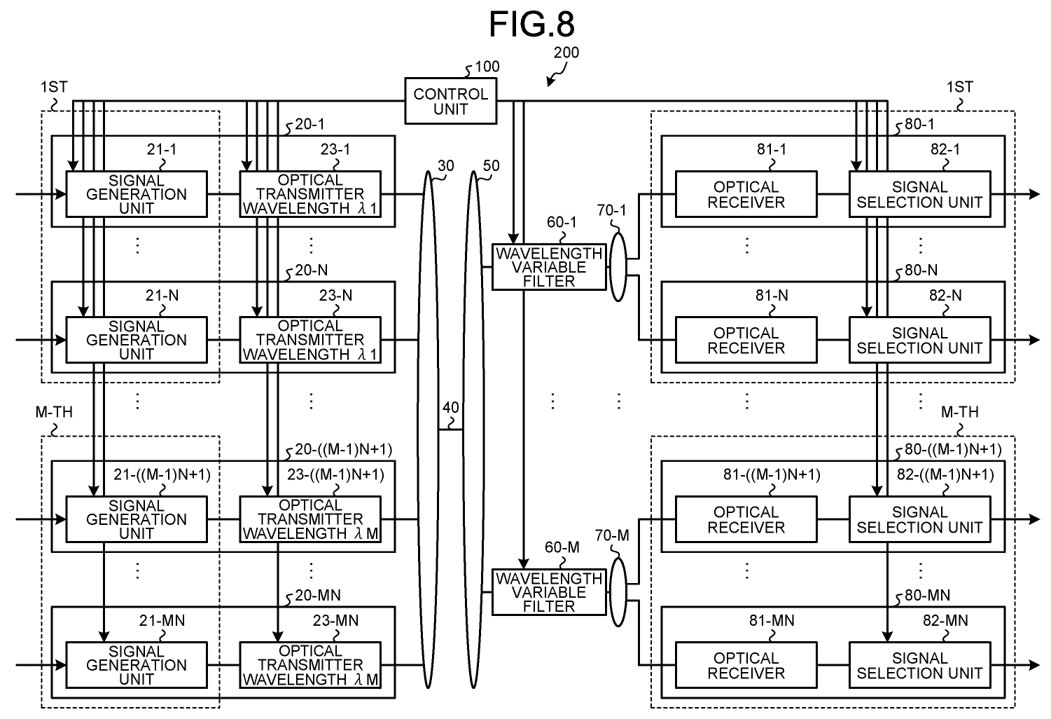

FIG. 8 is a diagram illustrating an exemplary configuration of the optical communication system 200 according to the third embodiment. The optical communication system 200 illustrated in FIG. 8 includes MN input ports and MN output ports (not illustrated), and performs switching between the MN input ports and the MN output ports using the TDM method and the WDM method. The optical communication system 200 includes signal generation units 21-1 to 21-MN, optical transmitters 23-1 to 23-MN, the optical coupler 30, the transmission path 40, the optical coupler 50, wavelength variable filters 60-1 to 60-M, optical couplers 70-1 to 70-M, optical receivers 81-1 to 81-MN, signal selection units 82-1 to 82-MN, and the control unit 100.

In the optical communication system 200, the signal generation unit 21-1 and the optical transmitter 23-1 constitute the optical transmission device 20-1, the signal generation unit 21-2 and the optical transmitter 23-2 constitute the optical transmission device 20-2, and the signal generation unit 21-MN and the optical transmitter 23-MN constitute an optical transmission device 20-MN. In addition, the optical receiver 81-1 and the signal selection unit 82-1 constitute the optical reception device 80-1, the optical receiver 81-2 and the signal selection unit 82-2 constitute the optical reception device 80-2, and the optical receiver 81-MN and the signal selection unit 82-MN constitute an optical reception device 80-MN. The optical coupler 30, the optical coupler 50, and the optical couplers 70-1 to 70-M are, for example, power splitters. Note that the optical coupler 30 and the optical coupler 50 may be integrated with the transmission path 40 to form a configuration of MN×M.

In the following description, the optical transmission devices 20-1 to 20-MN may be referred to as the optical transmission device 20 when they are not distinguished, the signal generation units 21-1 to 21-MN may be referred to as the signal generation unit 21 when they are not distinguished, and the optical transmitters 23-1 to 23-MN may be referred to as the optical transmitter 23 when they are not distinguished. In addition, the wavelength variable filters 60-1 to 60-M may be referred to as the wavelength variable filter 60 when they are not distinguished, and the optical couplers 70-1 to 70-M may be referred to as the optical coupler 70 when they are not distinguished. In addition, the optical reception devices 80-1 to 80-MN may be referred to as the optical reception device 80 when they are not distinguished, the optical receivers 81-1 to 81-MN may be referred to as the optical receiver 81 when they are not distinguished, and the signal selection units 82-1 to 82-MN may be referred to as the signal selection unit 82 when they are not distinguished. In addition, the optical coupler 30 may be referred to as the first optical coupler, the optical coupler 50 may be referred to as the second optical coupler, and the optical coupler 70 may be referred to as the third optical coupler.

As illustrated in FIG. 8, the optical communication system 200 includes the MN signal generation units 21. This is for transmitting N packet signals per wavelength with respect to the output wavelengths λ1 to λM of the optical transmitters 23. FIG. 8 indicates that the electrical packet signals generated by the signal generation units 21-1 to 21-N are input to the optical transmitters 23-1 to 23-N having the output wavelength λ1, the electrical packet signals generated by the signal generation units 21-N+1 to 21-2N are input to the optical transmitters 23-N+1 to 23-2N having the output wavelength λ2, and the data generated by the signal generation units 21-((M-1)N+1) to 21-MN are input to the optical transmitters 23-((M-1)N+1) to 23-MN having the output wavelength λM.

The signal generation units 21-1 to 21-MN acquire first data signals, i.e. electrical signals requested to be transferred, from the above-described input ports. In addition, the signal generation units 21-1 to 21-MN acquire the first control information from the control unit 100. The signal generation units 21-1 to 21-MN temporarily buffer the first data signals, allocate the communication resource allocation based on the transmission timing signal included in the first control signal, determine a bit rate, and generate and transmit electrical packet signals. The third embodiment is based on the assumption that the communication resource is time slots and wavelengths. Here, the control unit 100 controls the transmission timing signal for each signal generation unit 21 such that while an electrical packet signal is transmitted from the signal generation unit 21 of some optical transmission device 20, no electrical packet signal is transmitted from the signal generation unit 21 of another optical transmission device 20 that uses the same output wavelength λ. In addition, the control unit 100 determines, using the reference clock, the bit rate of the electrical packet signal that is transmitted from each signal generation unit 21.

For example, in a case where all the signal generation units 21-1 to 21-MN have transmission requests for electrical packet signals of the same size, the signal generation units 21-1, 21-N+1, and 21-((M-1)N+1) transmit the electrical packet signals during time slot 1 under the control of the control unit 100, and the other signal generation units 21 do not transmit the electrical packet signals during time slot 1 under the control of the control unit 100. In addition, the signal generation units 21-2, 21-N+2,..., and 21-((M-1)N+2) transmit the electrical packet signals during the next time slot 2 under the control of the control unit 100, and the other signal generation units 21 do not transmit the electrical packet signals during time slot 2 under the control of the control unit 100. The same applies hereinafter: the signal generation units 21-N, 21-2N,..., and 21-MN transmit the electrical packet signals during time slot N under the control of the control unit 100, and the other signal generation units 21 do not transmit the electrical packet signals during time slot N under the control of the control unit 100. Note that in the absence of simultaneous signal transmission requests from the MN signal generation units 21, the control unit 100 may perform control to reduce the total number of time slots in a certain time section according to the number of transmission requests. In addition, the control unit 100 may use the same width or different widths for the time slots in which the signal generation units 21-1 to 21-MN transmit electrical packet signals.

The control unit 100 distributes the reference clock, the transmission timing signal that is the communication resource allocation, and the routing information as the first control signal to the signal generation units 21-1 to 21-MN and the optical transmitters 23-1 to 23-MN. In addition, the control unit 100 distributes the transmission timing signal that is the communication resource allocation and the routing information as the second control signal to the wavelength variable filters 60-1 to 60-M and the signal selection units 82-1 to 82-MN. Note that the control unit 100 may also distribute the first control signal to the wavelength variable filters 60-1 to 60-M and the signal selection units 82-1 to 82-MN to distribute a unified type of control signal to each component, or may add different types of information to the control signals to be distributed to different components.

The signal generation units 21-1 to 21-MN transmit the first data signals as electrical packet signals to the corresponding optical transmitters 23-1 to 23-MN at the transmission timings determined by the control unit 100.

The optical transmitters 23-1 to 23-MN convert the electrical packet signals acquired from the corresponding signal generation units 21-1 to 21-MN into optical packet signals. The optical transmitters 23-1 to 23-MN transmit the optical packet signals generated through conversion to the optical coupler 30. Specifically, the optical transmitters 23-1 to 23-N convert the electrical packet signals into optical packet signals having the output wavelength λ1, the optical transmitters 23-N+1 to 23-2N convert the electrical packet signals into optical packet signals having the output wavelength λ2, and the optical transmitters 23-((M-1)N+1) to 23-MN convert the electrical packet signals into optical packet signals having the output wavelength λM. Note that in the example of FIG. 8, the signal generation unit 21 and the optical transmitter 23 are illustrated as separate blocks in the optical transmission device 20. However, the function of the signal generation unit 21 may be incorporated in the optical transmitter 23.

The optical coupler 30 couples the plurality of optical packet signals acquired from the optical transmitters 23-1 to 23-MN. The optical coupler 30 outputs the optical transmission signal generated by coupling the plurality of optical packet signals to the optical coupler 50 via the transmission path 40 which is an optical fiber.

The optical coupler 50 branches the optical transmission signal acquired via the transmission path 40 into a plurality of optical transmission signals. The optical coupler 50 outputs the optical transmission signals generated through branching to the wavelength variable filters 60-1 to 60-M.

The wavelength variable filters 60-1 to 60-M allow only the optical signals of a specific wavelength to pass through. In addition, the transmission wavelengths of the wavelength variable filters 60-1 to 60-M can be switched. In the present embodiment, each of the wavelength variable filters 60-1 to 60-M sets a transmission wavelength for optical transmission signals based on the routing information included in the second control information acquired from the control unit 100, and demultiplexes and outputs optical signals having the designated wavelength. The wavelength variable filters 60-1 to 60-M output, to the corresponding optical couplers 70-1 to 70-M, the optical transmission signals generated through demultiplexing based on the designated transmission wavelength. Specifically, the wavelength variable filter 60-1 outputs the optical transmission signal having the output wavelength λ1 to the optical coupler 70-1, the wavelength variable filter 60-2 outputs the optical transmission signal having the output wavelength λ2 to the optical coupler 70-2, and the wavelength variable filter 60-M outputs the optical transmission signal having the output wavelength λM to the optical coupler 70-M.

The optical couplers 70-1 to 70-M respectively branch the optical transmission signals acquired from the corresponding wavelength variable filters 60-1 to 60-M into a plurality of optical transmission signals having the same information. The optical couplers 70-1 to 70-M output the optical transmission signals generated through branching to the optical receivers 81-1 to 81-MN. Specifically, the optical coupler 70-1 branches the optical transmission signal having the output wavelength λ1, and outputs the resultant signals to the optical receivers 81-1 to 81-N. In addition, the optical coupler 70-2 branches the optical transmission signal having the output wavelength λ2, and outputs the resultant signals to the optical receivers 81-N+1 to 81-2N. The same applies hereinafter: the optical coupler 70-M branches the optical transmission signal having the output wavelength λM, and outputs the resultant signals to the optical receivers 81-((M-1)N+1) to 81-MN.

The optical receivers 81-1 to 81-MN convert the optical transmission signals received from the optical couplers 70-1 to 70-M into electrical transmission signals. The optical receivers 81-1 to 81-MN output the electrical transmission signals generated through conversion to the corresponding signal selection units 82-1 to 82-MN.

The signal selection units 82-1 to 82-MN select signals of designated time slots from the electrical transmission signals acquired from the corresponding optical receivers 81-1 to 81-MN based on the routing information included in the second control signal acquired from the control unit 100. Consequently, the optical communication system 200 can switch between the MN input ports and the MN output ports using the TDM method and the WDM method.

Note that the optical communication system 200 may transfer the second data signals selected by the signal selection units 82-1 to 82-MN to a subsequent-stage component, in which case the second data signals may be transferred as intermittent packet signals, or may be transferred after being converted into continuous signals at a reduced bit rate.

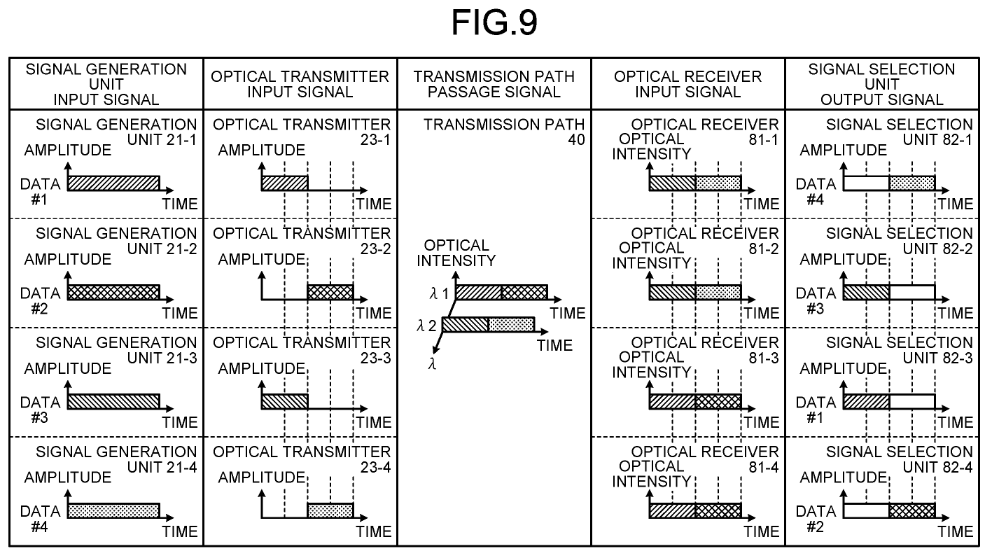

FIG. 9 is a diagram illustrating an example of signals transmitted in the optical communication system 200 according to the third embodiment. FIG. 9 also depicts the procedure for the operation of the optical communication system 200 according to the third embodiment. FIG. 9 illustrates, as an example in the case of M=2 and N=2, first data signals that are input signals to the signal generation units 21-1 to 21-4, packets as electrical signals that are input signals to the optical transmitters 23-1 to 23-4, optical transmission signals that are passage signals through the transmission path 40, optical transmission signals that are input signals to the optical receivers 81-1 to 81-4, and second data signals that are output signals from the signal selection units 82-1 to 82-4. As illustrated in FIG. 9, the first data signal of data #1 is input to the signal generation unit 21-1, the first data signal of data #2 is input to the signal generation unit 21-2, the first data signal of data #3 is input to the signal generation unit 21-3, and the first data signal of data #4 is input to the signal generation unit 21-4.

The signal generation units 21-1 to 21-4 equalize the bit rates of the electrical packet signals to be output from the respective signal generation units 21 based on the reference clock included in the first control signal acquired from the control unit 100. In addition, based on the transmission timing signal included in the first control signal acquired from the control unit 100, the signal generation units 21-1 to 21-4 determine the transmission timings of the electrical packet signals such that the signal generation units 21 of the optical transmission devices 20 that use the same wavelength when converting the electrical packet signals into optical packet signals do not transmit the electrical packet signals in the same time slot.

Specifically, in a case where all the signal generation units 21-1 to 21-4 have transmission requests for packet signals of the same size as in FIG. 9, the signal generation units 21-1 and 21-3 transmit the electrical packet signals, and the other signal generation units 21-2 and 21-4 do not transmit the electrical packet signals during the first time slot 1. During the second time slot 2, the signal generation units 21-2 and 21-4 transmit the electrical packet signals, and the other signal generation units 21-1 and 21-3 do not transmit the electrical packet signals. In this manner, the signal generation units 21-1 to 21-4 adjust the transmission timings of the electrical packet signals based on the transmission timing signal included in the first control signal acquired from the control unit 100.

The optical transmitters 23-1 to 23-4 convert the electrical packet signals transmitted at the determined transmission timings by the signal generation units 21-1 to 21-4 into optical packet signals. The optical coupler 30 couples the optical packet signals transmitted from the optical transmitters 23-1 to 23-4, and outputs the resultant signal as an optical transmission signal to the optical coupler 50 via the transmission path 40. The optical coupler 50 branches the optical transmission signal acquired via the transmission path 40, and outputs the resultant signals to the wavelength variable filters 60-1 and 60-2. The wavelength variable filter 60-1 allows the optical transmission signal having the output wavelength λ2 to pass through, and outputs the optical transmission signal having the output wavelength λ2 to the optical coupler 70-1. The wavelength variable filter 60-2 allows the optical transmission signal having the output wavelength λ1 to pass through, and outputs the optical transmission signal having the output wavelength λ1 to the optical coupler 70-2. The optical coupler 70-1 branches the optical transmission signal having the output wavelength λ2, and outputs the resultant signals to the optical receivers 81-1 and 81-2. The optical coupler 70-2 branches the optical transmission signal having the output wavelength λ1, and outputs the resultant signals to the optical receivers 81-3 and 81-4. As illustrated in FIG. 9, the optical transmission signals received by the optical receivers 81-1 and 81-2 from the optical coupler 70-1 are the same, and the optical transmission signals received by the optical receivers 81-3 and 81-4 from the optical coupler 70-2 are the same.

The optical receivers 81-1 to 81-4 convert the received optical transmission signals into electrical transmission signals, and output the electrical transmission signals to the corresponding signal selection units 82-1 to 82-4. The signal selection units 82-1 to 82-4 select signals of designated time slots from the received electrical packet signals based on the routing information included in the second control signal acquired from the control unit 100, and output the signals of the selected time slots as second data signals which are electrical signals.

As described above, in the present embodiment, the optical transmission devices 20-1 to 20-MN allocate time slots based on the first control signal to avoid collision with the optical packet signal transmitted from another optical transmission device 20 that uses the same wavelength, and transmit the optical packet signals. In addition, the optical reception devices 80-1 to 80-MN select signals of designated time slots from the electrical transmission signals based on the second control signal, and output the signals as second data signals.

A hardware configuration of the optical communication system 200 will be described. In the optical communication system 200, the optical couplers 70-1 to 70-M are power splitters as described above. The wavelength variable filters 60-1 to 60-M are implemented by processing circuitry. The processing circuitry may be a memory and a processor that executes a program stored in the memory, or may be dedicated hardware.

As described above, according to the present embodiment, the optical communication system 200 controls the transmission timing for the signal generation unit 21 of each optical transmission device 20 using the TDM method and the WDM method, that is, the time wavelength division multiplexing (TWDM) method, so that the matrix switch connection can be configured just with the passive components, namely the optical couplers 30, 50, and 70, without using an optical switch in the optical domain, which can improve the reliability. In addition, the optical communication system 200, which does not use an optical switch, can achieve low power consumption, space saving, weight reduction, and cost reduction.

On the other hand, the optical communication system 200 according to the third embodiment requires about several 10 us for wavelength switching of the wavelength variable filter 60, and thus requires a switching speed equivalent to that of an optical switch. However, in the optical communication system 200 according to the third embodiment, the compression rate of data is only ⅟(number of wavelengths), so that the load of system processing can be reduced.

### Fourth Embodiment

In the fourth embodiment, the optical communication system 200 with a configuration different from the configuration in the third embodiment performs switching on MN first data signals acquired from MN input ports using the TDM method and the WDM method, and outputs MN second data signals from MN output ports. Differences from the third embodiment will be described.

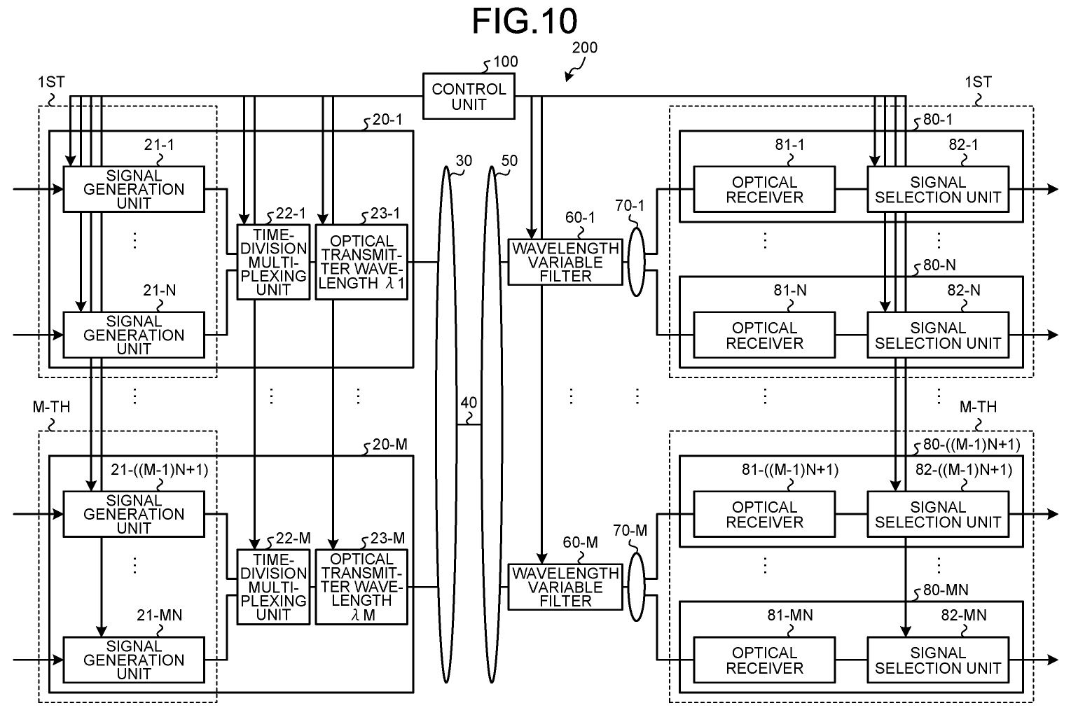

FIG. 10 is a diagram illustrating an exemplary configuration of the optical communication system 200 according to the fourth embodiment. The optical communication system 200 illustrated in FIG. 10 includes MN input ports and MN output ports (not illustrated), and performs switching between the MN input ports and the MN output ports using the TDM method and the WDM method. The optical communication system 200 includes the signal generation units 21-1 to 21-MN, time-division multiplexing units 22-1 to 22-M, the optical transmitters 23-1 to 23-M, the optical coupler 30, the transmission path 40, the optical coupler 50, the wavelength variable filters 60-1 to 60-M, the optical couplers 70-1 to 70-M, the optical receivers 81-1 to 81-MN, the signal selection units 82-1 to 82-MN, and the control unit 100.

In the optical communication system 200, the signal generation units 21-1 to 21-N, the time-division multiplexing unit 22-1, and the optical transmitter 23-1 constitute the optical transmission device 20-1, the signal generation units 21-N+1 to 21-2N, the time-division multiplexing unit 22-2, and the optical transmitter 23-2 constitute the optical transmission device 20-2, and the signal generation units 21-((M-1)N+1) to 21-MN, the time-division multiplexing unit 22-M, and the optical transmitter 23-M constitute the optical transmission device 20-M. In addition, the optical receiver 81-1 and the signal selection unit 82-1 constitute the optical reception device 80-1, the optical receiver 81-2 and the signal selection unit 82-2 constitute the optical reception device 80-2, and the optical receiver 81-MN and the signal selection unit 82-MN constitute the optical reception device 80-MN. The optical coupler 30, the optical coupler 50, and the optical couplers 70-1 to 70-M are, for example, power splitters. Note that the optical coupler 30 and the optical coupler 50 may be integrated with the transmission path 40 to form a configuration of M×M.

In the following description, the optical transmission devices 20-1 to 20-M may be referred to as the optical transmission device 20 when they are not distinguished, the signal generation units 21-1 to 21-MN may be referred to as the signal generation unit 21 when they are not distinguished, the time-division multiplexing units 22-1 to 22-M may be referred to as the time-division multiplexing unit 22 when they are not distinguished, and the optical transmitters 23-1 to 23-M may be referred to as the optical transmitter 23 when they are not distinguished. In addition, the wavelength variable filters 60-1 to 60-M may be referred to as the wavelength variable filter 60 when they are not distinguished, and the optical couplers 70-1 to 70-M may be referred to as the optical coupler 70 when they are not distinguished. In addition, the optical reception devices 80-1 to 80-MN may be referred to as the optical reception device 80 when they are not distinguished, the optical receivers 81-1 to 81-MN may be referred to as the optical receiver 81 when they are not distinguished, and the signal selection units 82-1 to 82-MN may be referred to as the signal selection unit 82 when they are not distinguished. In addition, the optical coupler 30 may be referred to as the first optical coupler, the optical coupler 50 may be referred to as the second optical coupler, and the optical coupler 70 may be referred to as the third optical coupler.

As illustrated in FIG. 10, the optical communication system 200 includes the MN signal generation units 21. This is for transmitting N packet signals per wavelength with respect to the output wavelengths A1 to λM of the optical transmitters 23. In FIG. 10, in the optical transmission device 20-1, the electrical packet signals generated by the signal generation units 21-1 to 21-N are combined by the time-division multiplexing unit 22-1 and input to the optical transmitter 23-1 having the output wavelength λ1. In the optical transmission device 20-2, the electrical packet signals generated by the signal generation units 21-N+1 to 21-2N are combined by the time-division multiplexing unit 22-2 and input to the optical transmitter 23-2 having the output wavelength λ2. The same applies hereinafter: in the optical transmission device 20-M, the electrical packet signals generated by the signal generation units 21-((M-1)N+1) to 21-MN are combined by the time-division multiplexing unit 22-M and input to the optical transmitter 23-M having the output wavelength λM.

The signal generation units 21-1 to 21-MN acquire first data signals, i.e. electrical signals requested to be transferred, from the above-described input ports. In addition, the signal generation units 21-1 to 21-MN acquire the first control information from the control unit 100. The signal generation units 21-1 to 21-MN temporarily buffer the first data signals, allocate the communication resource allocation based on the transmission timing signal included in the first control signal, determine a bit rate, and generate and transmit electrical packet signals. The fourth embodiment is based on the assumption that the communication resource is time slots and wavelengths. Here, the control unit 100 controls the transmission timing signal for each signal generation unit 21 such that while an electrical packet signal is transmitted from some signal generation unit 21, no electrical packet signal is transmitted from another signal generation unit 21 of the same optical transmission device 20. In addition, the control unit 100 determines, using the reference clock, the bit rate of the electrical packet signal that is transmitted from each signal generation unit 21.

For example, in a case where all the signal generation units 21-1 to 21-MN have transmission requests for electrical packet signals of the same size, the signal generation units 21-1, 21-N+1, and 21-((M-1)N+1) transmit the electrical packet signals during time slot 1 under the control of the control unit 100, and the other signal generation units 21 do not transmit the electrical packet signals during time slot 1 under the control of the control unit 100. In addition, the signal generation units 21-2, 21-N+2,..., and 21-((M-1)N+2) transmit the electrical packet signals during the next time slot 2 under the control of the control unit 100, and the other signal generation units 21 do not transmit the electrical packet signals during time slot 2 under the control of the control unit 100. The same applies hereinafter: the signal generation units 21-N, 21-2N,..., and 21-MN transmit the electrical packet signals during time slot N under the control of the control unit 100, and the other signal generation units 21 do not transmit the electrical packet signals during time slot N under the control of the control unit 100. Note that in the absence of simultaneous signal transmission requests from the MN signal generation units 21, the control unit 100 may perform control to reduce the total number of time slots in a certain time section according to the number of transmission requests. In addition, the control unit 100 may use the same width or different widths for the time slots in which the signal generation units 21-1 to 21-MN transmit electrical packet signals.

The control unit 100 distributes the reference clock, the transmission timing signal that is the communication resource allocation, and the routing information as the first control signal to the signal generation units 21-1 to 21-MN, the time-division multiplexing units 22-1 to 22-M, and the optical transmitters 23-1 to 23-M. In addition, the control unit 100 distributes the transmission timing signal that is the communication resource allocation and the routing information as the second control signal to the wavelength variable filters 60-1 to 60-M and the signal selection units 82-1 to 82-MN. Note that the control unit 100 may also distribute the first control signal to the wavelength variable filters 60-1 to 60-M and the signal selection units 82-1 to 82-MN to distribute a unified type of control signal to each component, or may add different types of information to the control signals to be distributed to different components.

The signal generation units 21-1 to 21-MN transmit the first data signals as electrical packet signals to the corresponding time-division multiplexing units 22-1 to 22-M at the transmission timings determined by the control unit 100.

Each of the time-division multiplexing units 22-1 to 22-M multiplexes the N electrical packet signals acquired from the N signal generation units 21 of the same optical transmission device 20 based on the routing information included in the first control signal acquired from the control unit 100, and outputs the resultant signal to the optical transmitter 23 of the same optical transmission device 20.

The optical transmitters 23-1 to 23-M convert the electrical packet signals acquired from the corresponding time-division multiplexing units 22-1 to 22-M into optical packet signals. The optical transmitters 23-1 to 23-M transmit the optical packet signals generated through conversion to the optical coupler 30. Specifically, the optical transmitter 23-1 converts the electrical packet signal into an optical packet signal having the output wavelength λ1, the optical transmitter 23-2 converts the electrical packet signal into an optical packet signal having the output wavelength λ2, and the optical transmitter 23-M converts the electrical packet signal into an optical packet signal having the output wavelength λM. Note that in the example of FIG. 10, the signal generation unit 21, the time-division multiplexing unit 22, and the optical transmitter 23 are illustrated as separate blocks in the optical transmission device 20. However, the functions of the signal generation unit 21 and the time-division multiplexing unit 22 may be incorporated in the optical transmitter 23.

The subsequent operations of the optical coupler 30, the optical coupler 50, the wavelength variable filters 60-1 to 60-M, the optical couplers 70-1 to 70-M, the optical receivers 81-1 to 81-MN, and the signal selection units 82-1 to 82-MN are similar to those in the third embodiment.

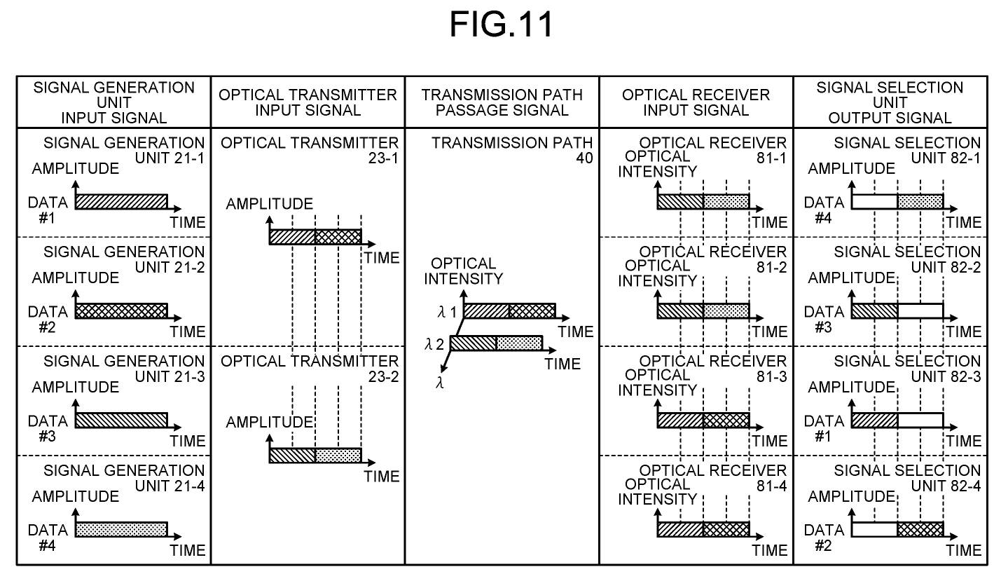

FIG. 11 is a diagram illustrating an example of signals transmitted in the optical communication system 200 according to the fourth embodiment. FIG. 11 also depicts the procedure for the operation of the optical communication system 200 according to the fourth embodiment. FIG. 11 illustrates, as an example in the case of M=2 and N=2, first data signals that are input signals to the signal generation units 21-1 to 21-4, packets as electrical signals that are input signals to the optical transmitters 23-1 and 23-2, optical transmission signals that are passage signals through the transmission path 40, optical transmission signals that are input signals to the optical receivers 81-1 to 81-4, and second data signals that are output signals from the signal selection units 82-1 to 82-4. As illustrated in FIG. 11, the first data signal of data #1 is input to the signal generation unit 21-1, the first data signal of data #2 is input to the signal generation unit 21-2, the first data signal of data #3 is input to the signal generation unit 21-3, and the first data signal of data #4 is input to the signal generation unit 21-4.

The signal generation units 21-1 to 21-4 equalize the bit rates of the electrical packet signals to be output from the respective signal generation units 21 based on the reference clock included in the first control signal acquired from the control unit 100. In addition, based on the transmission timing signal included in the first control signal acquired from the control unit 100, the signal generation units 21-1 to 21-4 determine the transmission timings of the electrical packet signals such that the signal generation units 21 of the same optical transmission devices 20 do not transmit the electrical packet signals in the same time slot.

Specifically, in a case where all the signal generation units 21-1 to 21-4 have transmission requests for packet signals of the same size as in FIG. 11, the signal generation units 21-1 and 21-3 transmit the electrical packet signals, and the other signal generation units 21-2 and 21-4 do not transmit the electrical packet signals during the first time slot 1. During the second time slot 2, the signal generation units 21-2 and 21-4 transmit the electrical packet signals, and the other signal generation units 21-1 and 21-3 do not transmit the electrical packet signals. In this manner, the signal generation units 21-1 to 21-4 adjust the transmission timings of the electrical packet signals based on the transmission timing signal included in the first control signal acquired from the control unit 100.

The time-division multiplexing unit 22-1 multiplexes the electrical packet signals acquired from the signal generation units 21-1 and 21-2 of the same optical transmission device 20-1 based on the routing information included in the first control signal acquired from the control unit 100, and outputs the resultant signal to the optical transmitter 23-1 of the same optical transmission device 20-1. The time-division multiplexing unit 22-2 multiplexes the electrical packet signals acquired from the signal generation units 21-3 and 21-4 of the same optical transmission device 20-2 based on the routing information included in the first control signal acquired from the control unit 100, and outputs the resultant signal to the optical transmitter 23-2 of the same optical transmission device 20-2.

The subsequent operations of the optical transmitters 23-1 and 23-2, the optical coupler 30, the optical coupler 50, the wavelength variable filters 60-1 and 60-2, the optical couplers 70-1 and 70-2, the optical receivers 81-1 to 81-4, and the signal selection units 82-1 to 82-4 are similar to those in the third embodiment.

As described above, the optical transmission devices 20-1 to 20-M include the plurality of signal generation units 21, the plurality of time-division multiplexing units 22, and the plurality of optical transmitters 23. The plurality of signal generation units 21 each buffer the first data signal, allocate a time slot based on the first control signal, determine a bit rate, and generate an electrical packet signal. The time-division multiplexing unit 22 multiplexes a plurality of electrical packet signals acquired from a plurality of signal generation units 21 of the same optical transmission device 20. The optical transmitter 23 converts the electrical packet signal generated through multiplexing by the time-division multiplexing unit 22 of the same optical transmission device 20 into an optical packet signal using a different wavelength for each of the plurality of optical transmission devices 20. In addition, the optical reception devices 80-1 to 80-MN select signals of designated time slots from the electrical transmission signals based on the second control signal, and output the signals as second data signals.

A hardware configuration of the optical communication system 200 will be described. In the optical communication system 200, the time-division multiplexing units 22-1 to 22-M are implemented by processing circuitry. The processing circuitry may be a memory and a processor that executes a program stored in the memory, or may be dedicated hardware.

As described above, according to the present embodiment, the optical communication system 200 controls the transmission timing for the signal generation unit 21 of each optical transmission device 20 using the TDM method and the WDM method, that is, the TWDM method, so that the matrix switch connection can be configured just with the passive components, namely the optical couplers 30, 50, and 70, without using an optical switch in the optical domain, which can improve the reliability. In addition, the optical communication system 200, which does not use an optical switch, can achieve low power consumption, space saving, weight reduction, and cost reduction.

On the other hand, the optical communication system 200 according to the fourth embodiment requires about several 10 us for wavelength switching of the wavelength variable filter 60, and thus requires a switching speed equivalent to that of an optical switch. However, in the optical communication system 200 according to the fourth embodiment, the compression rate of data is only ⅟(number of wavelengths), so that the load of system processing can be reduced.

In addition, as compared with the optical communication system 200 according to the third embodiment, the optical communication system 200 according to the fourth embodiment can reduce the number of optical transmitters 23 given that the total number of input ports is fixed, and thus can achieve low power consumption, space saving, weight reduction, and cost reduction.

### Fifth Embodiment

In the third embodiment, the optical communication system 200 controls the output wavelength λ of the optical transmission signals to pass through using the wavelength variable filters 60-1 to 60-M. In the fifth embodiment, the optical transmission device 20 controls the output wavelength λ of the optical transmission signals to be transmitted. Differences from the third embodiment will be described.

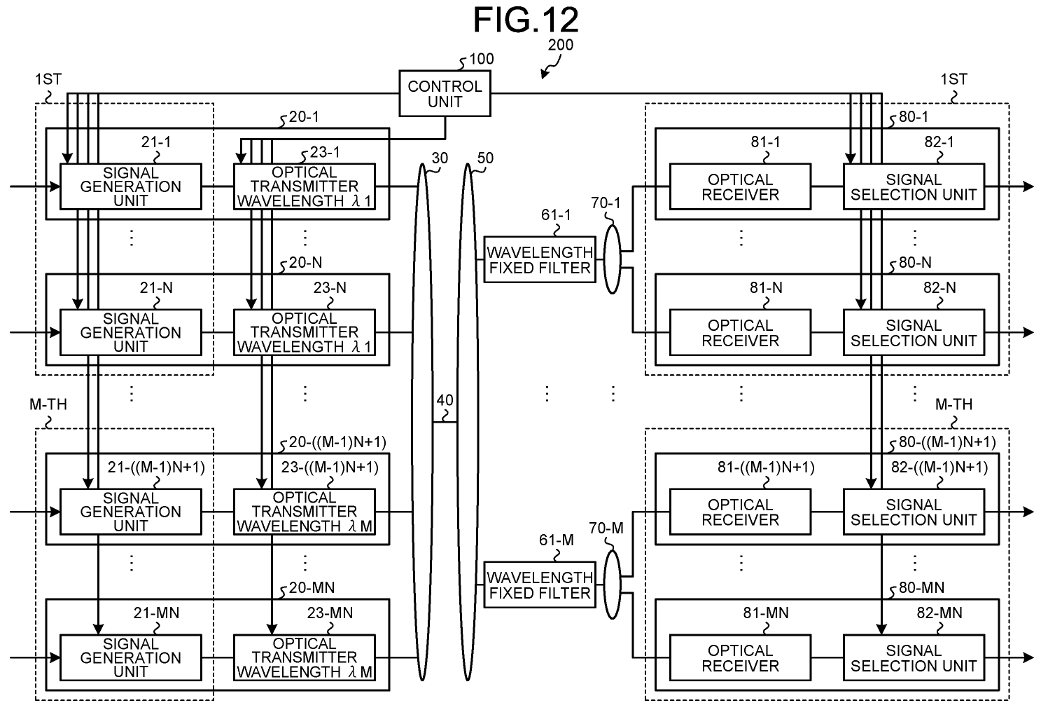

FIG. 12 is a diagram illustrating an exemplary configuration of the optical communication system 200 according to the fifth embodiment. The optical communication system 200 illustrated in FIG. 12 includes MN input ports and MN output ports (not illustrated), and performs switching between the MN input ports and the MN output ports using the TDM method and the WDM method. The optical communication system 200 includes the signal generation units 21-1 to 21-MN, the optical transmitters 23-1 to 23-MN, the optical coupler 30, the transmission path 40, the optical coupler 50, wavelength fixed filters 61-1 to 61-M, the optical couplers 70-1 to 70-M, the optical receivers 81-1 to 81-MN, the signal selection units 82-1 to 82-MN, and the control unit 100.

In the optical communication system 200, the signal generation unit 21-1 and the optical transmitter 23-1 constitute the optical transmission device 20-1, the signal generation unit 21-2 and the optical transmitter 23-2 constitute the optical transmission device 20-2, and the signal generation unit 21-MN and the optical transmitter 23-MN constitute the optical transmission device 20-MN. In addition, the optical receiver 81-1 and the signal selection unit 82-1 constitute the optical reception device 80-1, the optical receiver 81-2 and the signal selection unit 82-2 constitute the optical reception device 80-2, and the optical receiver 81-MN and the signal selection unit 82-MN constitute the optical reception device 80-MN. The optical coupler 30, the optical coupler 50, and the optical couplers 70-1 to 70-M are, for example, power splitters. Note that the optical coupler 30 and the optical coupler 50 may be integrated with the transmission path 40 to form a configuration of MN × M.

In the following description, the optical transmission devices 20-1 to 20-MN may be referred to as the optical transmission device 20 when they are not distinguished, the signal generation units 21-1 to 21-MN may be referred to as the signal generation unit 21 when they are not distinguished, and the optical transmitters 23-1 to 23-MN may be referred to as the optical transmitter 23 when they are not distinguished. In addition, the wavelength fixed filters 61-1 to 61-M may be referred to as the wavelength fixed filter 61 when they are not distinguished, and the optical couplers 70-1 to 70-M may be referred to as the optical coupler 70 when they are not distinguished. In addition, the optical reception devices 80-1 to 80-MN may be referred to as the optical reception device 80 when they are not distinguished, the optical receivers 81-1 to 81-MN may be referred to as the optical receiver 81 when they are not distinguished, and the signal selection units 82-1 to 82-MN may be referred to as the signal selection unit 82 when they are not distinguished. In addition, the optical coupler 30 may be referred to as the first optical coupler, the optical coupler 50 may be referred to as the second optical coupler, and the optical coupler 70 may be referred to as the third optical coupler.

As illustrated in FIG. 12, the optical communication system 200 includes the MN signal generation units 21. This is for transmitting N packet signals per wavelength with respect to the output wavelengths λ1 to λM of the optical transmitters 23. FIG. 12 indicates that the electrical packet signals generated by the signal generation units 21-1 to 21-N are input to the optical transmitters 23-1 to 23-N having the output wavelength λ1, the electrical packet signals generated by the signal generation units 21-N+1 to 21-2N are input to the optical transmitters 23-N+1 to 23-2N having the output wavelength λ2, and the data generated by the signal generation units 21-((M-1)N+1) to 21-MN are input to the optical transmitters 23-((M-1)N+1) to 23-MN having the output wavelength λM.

The signal generation units 21-1 to 21-MN acquire first data signals, i.e. electrical signals requested to be transferred, from the above-described input ports. In addition, the signal generation units 21-1 to 21-MN acquire the first control information from the control unit 100. The signal generation units 21-1 to 21-MN temporarily buffer the first data signals, allocate the communication resource allocation based on the transmission timing signal included in the first control signal, determine a bit rate, and generate and transmit electrical packet signals. The fifth embodiment is based on the assumption that the communication resource is time slots and wavelengths. Here, the control unit 100 controls the transmission timing signal for each signal generation unit 21 such that while an electrical packet signal is transmitted from the signal generation unit 21 of some optical transmission device 20, no electrical packet signal is transmitted from the signal generation unit 21 of another optical transmission device 20 that uses the same output wavelength λ. In addition, the control unit 100 determines, using the reference clock, the bit rate of the electrical packet signal that is transmitted from each signal generation unit 21.

For example, in a case where all the signal generation units 21-1 to 21-MN have transmission requests for electrical packet signals of the same size, the signal generation units 21-1, 21-N+1, and 21-((M-1)N+1) transmit the electrical packet signals during time slot 1 under the control of the control unit 100, and the other signal generation units 21 do not transmit the electrical packet signals during time slot 1 under the control of the control unit 100. In addition, the signal generation units 21-2, 21-N+2,..., and 21-((M-1)N+2) transmit the electrical packet signals during the next time slot 2 under the control of the control unit 100, and the other signal generation units 21 do not transmit the electrical packet signals during time slot 2 under the control of the control unit 100. The same applies hereinafter: the signal generation units 21-N, 21-2N,..., and 21-MN transmit the electrical packet signals during time slot N under the control of the control unit 100, and the other signal generation units 21 do not transmit the electrical packet signals during time slot N under the control of the control unit 100. Note that in the absence of simultaneous signal transmission requests from the MN signal generation units 21, the control unit 100 may perform control to reduce the total number of time slots in a certain time section according to the number of transmission requests. In addition, the control unit 100 may use the same width or different widths for the time slots in which the signal generation units 21-1 to 21-MN transmit electrical packet signals.

The control unit 100 distributes the reference clock, the transmission timing signal that is the communication resource allocation, and the routing information as the first control signal to the signal generation units 21-1 to 21-MN and the optical transmitters 23-1 to 23-MN. In addition, the control unit 100 distributes the transmission timing signal that is the communication resource allocation and the routing information as the second control signal to the signal selection units 82-1 to 82-MN. Note that the control unit 100 may also distribute the first control signal to the signal selection units 82-1 to 82-MN to distribute a unified type of control signal to each component, or may add different types of information to the control signals to be distributed to different components.

The signal generation units 21-1 to 21-MN transmit the first data signals as electrical packet signals to the corresponding optical transmitters 23-1 to 23-MN at the transmission timings determined by the control unit 100.

The optical transmitters 23-1 to 23-MN convert the electrical packet signals acquired from the corresponding signal generation units 21-1 to 21-MN into optical packet signals. In the present embodiment, the optical transmitters 23-1 to 23-MN can generate optical signals set at the designated output wavelength λ, specifically, one of the output wavelengths λ1 to λM, based on the routing information included in the first control information acquired from the control unit 100. The optical transmitters 23-1 to 23-MN transmit the optical packet signals generated through conversion to the optical coupler 30. Specifically, the optical transmitters 23-1 to 23-N convert the electrical packet signals into optical packet signals having the output wavelength λ1, the optical transmitters 23-N+1 to 23-2N convert the electrical packet signals into optical packet signals having the output wavelength λ2, and the optical transmitters 23-((M-1)N+1) to 23-MN convert the electrical packet signals into optical packet signals having the output wavelength λM. Note that in the example of FIG. 12, the signal generation unit 21 and the optical transmitter 23 are illustrated as separate blocks in the optical transmission device 20. However, the function of the signal generation unit 21 may be incorporated in the optical transmitter 23.

The optical coupler 30 couples the plurality of optical packet signals acquired from the optical transmitters 23-1 to 23-MN. The optical coupler 30 outputs the optical transmission signal generated by coupling the plurality of optical packet signals to the optical coupler 50 via the transmission path 40 which is an optical fiber.

The optical coupler 50 branches the optical transmission signal acquired via the transmission path 40 into a plurality of optical transmission signals. The optical coupler 50 outputs the optical transmission signals generated through branching to the wavelength fixed filters 61-1 to 61-M.

The wavelength fixed filters 61-1 to 61-M allow only the optical signals of a set specific wavelength, that is, a transmission wavelength, to pass through. The wavelength fixed filters 61-1 to 61-M output, to the corresponding optical couplers 70-1 to 70-M, the optical transmission signals generated through demultiplexing based on the set transmission wavelength. Specifically, the wavelength fixed filter 61-1 outputs the optical transmission signal having the output wavelength λ1 to the optical coupler 70-1, the wavelength fixed filter 61-2 outputs the optical transmission signal having the output wavelength λ2 to the optical coupler 70-2, and the wavelength fixed filter 61-M outputs the optical transmission signal having the output wavelength λM to the optical coupler 70-M.

The subsequent operations of the optical couplers 70-1 to 70-M, the optical receivers 81-1 to 81-MN, and the signal selection units 82-1 to 82-MN are similar to those in the third embodiment. Consequently, the optical communication system 200 can switch between the MN input ports and the MN output ports using the TDM method and the WDM method.

Note that the optical communication system 200 may transfer the second data signals selected by the signal selection units 82-1 to 82-MN to a subsequent-stage component, in which case the second data signals may be transferred as intermittent packet signals, or may be transferred after being converted into continuous signals at a reduced bit rate.

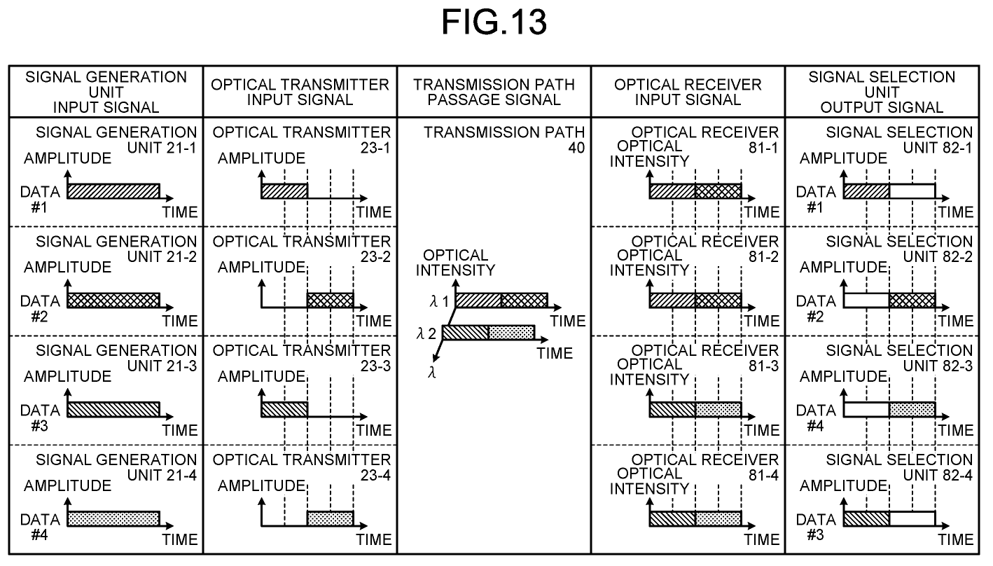

FIG. 13 is a diagram illustrating an example of signals transmitted in the optical communication system 200 according to the fifth embodiment. FIG. 13 also depicts the procedure for the operation of the optical communication system 200 according to the fifth embodiment. FIG. 13 illustrates, as an example in the case of M=2 and N=2, first data signals that are input signals to the signal generation units 21-1 to 21-4, packets as electrical signals that are input signals to the optical transmitters 23-1 to 23-4, optical transmission signals that are passage signals through the transmission path 40, optical transmission signals that are input signals to the optical receivers 81-1 to 81-4, and second data signals that are output signals from the signal selection units 82-1 to 82-4. As illustrated in FIG. 13, the first data signal of data #1 is input to the signal generation unit 21-1, the first data signal of data #2 is input to the signal generation unit 21-2, the first data signal of data #3 is input to the signal generation unit 21-3, and the first data signal of data #4 is input to the signal generation unit 21-4.

The signal generation units 21-1 to 21-4 equalize the bit rates of the electrical packet signals to be output from the respective signal generation units 21 based on the reference clock included in the first control signal acquired from the control unit 100. In addition, based on the transmission timing signal included in the first control signal acquired from the control unit 100, the signal generation units 21-1 to 21-4 determine the transmission timings of the electrical packet signals such that the signal generation units 21 of the optical transmission devices 20 that use the same wavelength when converting the electrical packet signals into optical packet signals do not transmit the electrical packet signals in the same time slot.

Specifically, in a case where all the signal generation units 21-1 to 21-4 have transmission requests for packet signals of the same size as in FIG. 13, the signal generation units 21-1 and 21-3 transmit the electrical packet signals, and the other signal generation units 21-2 and 21-4 do not transmit the electrical packet signals during the first time slot 1. During the second time slot 2, the signal generation units 21-2 and 21-4 transmit the electrical packet signals, and the other signal generation units 21-1 and 21-3 do not transmit the electrical packet signals. In this manner, the signal generation units 21-1 to 21-4 adjust the transmission timings of the electrical packet signals based on the transmission timing signal included in the first control signal acquired from the control unit 100.

The optical transmitters 23-1 to 23-4 convert the electrical packet signals transmitted at the determined transmission timings by the signal generation units 21-1 to 21-4 into optical packet signals having the designated output wavelength λ based on the routing information included in the first control information acquired from the control unit 100. The optical coupler 30 couples the optical packet signals transmitted from the optical transmitters 23-1 to 23-4, and outputs the resultant signal as an optical transmission signal to the optical coupler 50 via the transmission path 40. The optical coupler 50 branches the optical transmission signal acquired via the transmission path 40, and outputs the resultant signals to the wavelength fixed filters 61-1 and 61-2. The wavelength fixed filter 61-1 allows the optical transmission signal having the output wavelength λ1 to pass through, and outputs the optical transmission signal having the output wavelength λ1 to the optical coupler 70-1. The wavelength fixed filter 61-2 allows the optical transmission signal having the output wavelength λ2 to pass through, and outputs the optical transmission signal having the output wavelength λ2 to the optical coupler 70-2.

The subsequent operations of the optical couplers 70-1 and 70-2, the optical receivers 81-1 to 81-4, and the signal selection units 82-1 to 82-4 are similar to those in the third embodiment.

As described above, in the present embodiment, the optical transmission devices 20-1 to 20-MN set, based on the routing information included in the first control signal, the wavelength of the wavelength variable light source for use in converting the first data signal into an optical packet signal, allocate time slots to avoid collision with the optical packet signal transmitted from another optical transmission device 20 that uses the same wavelength, and transmit the optical packet signals. In addition, the optical reception devices 80-1 to 80-MN select signals of designated time slots from the electrical transmission signals based on the second control signal, and output the signals as second data signals.

A hardware configuration of the optical communication system 200 will be described. In the optical communication system 200, the wavelength fixed filters 61-1 to 61-M are implemented by processing circuitry. The processing circuitry may be a memory and a processor that executes a program stored in the memory, or may be dedicated hardware.

As described above, according to the present embodiment, the optical communication system 200 controls the transmission timing for the signal generation unit 21 of each optical transmission device 20 using the TDM method and the WDM method, that is, the TWDM method, so that the matrix switch connection can be configured just with the passive components, namely the optical couplers 30, 50, and 70, without using an optical switch in the optical domain, which can improve the reliability. In addition, the optical communication system 200, which does not use an optical switch, can achieve low power consumption, space saving, weight reduction, and cost reduction.

On the other hand, the optical communication system 200 according to the fifth embodiment requires about several 10 us for wavelength switching of the variable wavelength light source provided in the optical transmitter 23 of the optical transmission device 20, and thus requires a switching speed equivalent to that of an optical switch. However, in the optical communication system 200 according to the fifth embodiment, the compression rate of data is only ⅟(number of wavelengths), so that the load of system processing can be reduced.

### Sixth Embodiment

In the sixth embodiment, the optical communication system 200 with a configuration different from the configuration in the fifth embodiment performs switching on MN first data signals acquired from MN input ports using the TDM method and the WDM method, and outputs MN second data signals from MN output ports. Differences from the fourth and fifth embodiments will be described.

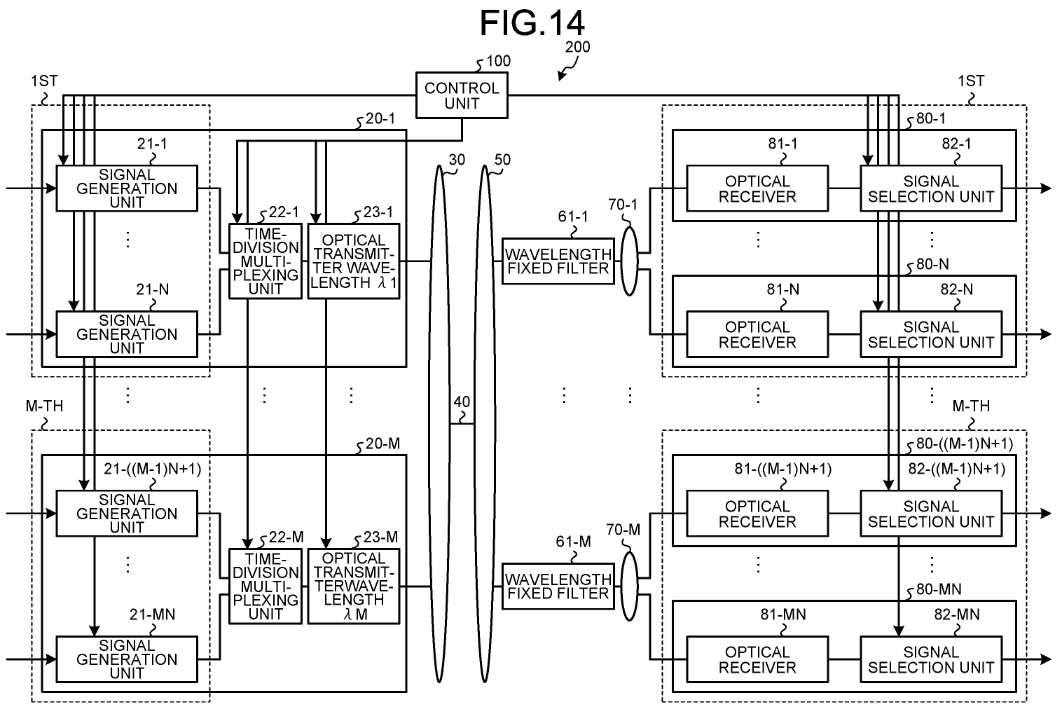

FIG. 14 is a diagram illustrating an exemplary configuration of the optical communication system 200 according to the sixth embodiment. The optical communication system 200 illustrated in FIG. 14 includes MN input ports and MN output ports (not illustrated), and performs switching between the MN input ports and the MN output ports using the TDM method and the WDM method. The optical communication system 200 includes the signal generation units 21-1 to 21-MN, the time-division multiplexing units 22-1 to 22-M, the optical transmitters 23-1 to 23-M, the optical coupler 30, the transmission path 40, the optical coupler 50, the wavelength fixed filters 61-1 to 61-M, the optical couplers 70-1 to 70-M, the optical receivers 81-1 to 81-MN, the signal selection units 82-1 to 82-MN, and the control unit 100.

In the optical communication system 200, the signal generation units 21-1 to 21-N, the time-division multiplexing unit 22-1, and the optical transmitter 23-1 constitute the optical transmission device 20-1, the signal generation units 21-N+1 to 21-2N, the time-division multiplexing unit 22-2, and the optical transmitter 23-2 constitute the optical transmission device 20-2, and the signal generation units 21-((M-1)N+1) to 21-MN, the time-division multiplexing unit 22-M, and the optical transmitter 23-M constitute the optical transmission device 20-M. In addition, the optical receiver 81-1 and the signal selection unit 82-1 constitute the optical reception device 80-1, the optical receiver 81-2 and the signal selection unit 82-2 constitute the optical reception device 80-2, and the optical receiver 81-MN and the signal selection unit 82-MN constitute the optical reception device 80-MN. The optical coupler 30, the optical coupler 50, and the optical couplers 70-1 to 70-M are, for example, power splitters. Note that the optical coupler 30 and the optical coupler 50 may be integrated with the transmission path 40 to form a configuration of M×M.

In the following description, the optical transmission devices 20-1 to 20-M may be referred to as the optical transmission device 20 when they are not distinguished, the signal generation units 21-1 to 21-MN may be referred to as the signal generation unit 21 when they are not distinguished, the time-division multiplexing units 22-1 to 22-M may be referred to as the time-division multiplexing unit 22 when they are not distinguished, and the optical transmitters 23-1 to 23-M may be referred to as the optical transmitter 23 when they are not distinguished. In addition, the wavelength fixed filters 61-1 to 61-M may be referred to as the wavelength fixed filter 61 when they are not distinguished, and the optical couplers 70-1 to 70-M may be referred to as the optical coupler 70 when they are not distinguished. In addition, the optical reception devices 80-1 to 80-MN may be referred to as the optical reception device 80 when they are not distinguished, the optical receivers 81-1 to 81-MN may be referred to as the optical receiver 81 when they are not distinguished, and the signal selection units 82-1 to 82-MN may be referred to as the signal selection unit 82 when they are not distinguished. In addition, the optical coupler 30 may be referred to as the first optical coupler, the optical coupler 50 may be referred to as the second optical coupler, and the optical coupler 70 may be referred to as the third optical coupler.

As illustrated in FIG. 14, the optical communication system 200 includes the MN signal generation units 21. This is for transmitting N packet signals per wavelength with respect to the output wavelengths λ1 to λM of the optical transmitters 23. In FIG. 14, in the optical transmission device 20-1, the electrical packet signals generated by the signal generation units 21-1 to 21-N are combined by the time-division multiplexing unit 22-1 and input to the optical transmitter 23-1 having the output wavelength λ1. In the optical transmission device 20-2, the electrical packet signals generated by the signal generation units 21-N+1 to 21-2N are combined by the time-division multiplexing unit 22-2 and input to the optical transmitter 23-2 having the output wavelength λ2. The same applies hereinafter: in the optical transmission device 20-M, the electrical packet signals generated by the signal generation units 21-((M-1)N+1) to 21-MN are combined by the time-division multiplexing unit 22-M and input to the optical transmitter 23-M having the output wavelength λM.

The signal generation units 21-1 to 21-MN acquire first data signals, i.e. electrical signals requested to be transferred, from the above-described input ports. In addition, the signal generation units 21-1 to 21-MN acquire the first control information from the control unit 100. The signal generation units 21-1 to 21-MN temporarily buffer the first data signals, allocate the communication resource allocation based on the transmission timing signal included in the first control signal, determine a bit rate, and generate and transmit electrical packet signals. The sixth embodiment is based on the assumption that the communication resource is time slots and wavelengths. Here, the control unit 100 controls the transmission timing signal for each signal generation unit 21 such that while an electrical packet signal is transmitted from some signal generation unit 21, no electrical packet signal is transmitted from another signal generation unit 21 of the same optical transmission device 20. In addition, the control unit 100 determines, using the reference clock, the bit rate of the electrical packet signal that is transmitted from each signal generation unit 21.

For example, in a case where all the signal generation units 21-1 to 21-MN have transmission requests for electrical packet signals of the same size, the signal generation units 21-1, 21-N+1, and 21-((M-1)N+1) transmit the electrical packet signals during time slot 1 under the control of the control unit 100, and the other signal generation units 21 do not transmit the electrical packet signals during time slot 1 under the control of the control unit 100. In addition, the signal generation units 21-2, 21-N+2,..., and 21-((M-1)N+2) transmit the electrical packet signals during the next time slot 2 under the control of the control unit 100, and the other signal generation units 21 do not transmit the electrical packet signals during time slot 2 under the control of the control unit 100. The same applies hereinafter: the signal generation units 21-N, 21-2N,..., and 21-MN transmit the electrical packet signals during time slot N under the control of the control unit 100, and the other signal generation units 21 do not transmit the electrical packet signals during time slot N under the control of the control unit 100. Note that in the absence of simultaneous signal transmission requests from the MN signal generation units 21, the control unit 100 may perform control to reduce the total number of time slots in a certain time section according to the number of transmission requests. In addition, the control unit 100 may use the same width or different widths for the time slots in which the signal generation units 21-1 to 21-MN transmit electrical packet signals.

The control unit 100 distributes the reference clock, the transmission timing signal that is the communication resource allocation, and the routing information as the first control signal to the signal generation units 21-1 to 21-MN, the time-division multiplexing units 22-1 to 22-M, and the optical transmitters 23-1 to 23-M. In addition, the control unit 100 distributes the transmission timing signal that is the communication resource allocation and the routing information as the second control signal to the wavelength fixed filters 61-1 to 61-M and the signal selection units 82-1 to 82-MN. Note that the control unit 100 may also distribute the first control signal to the wavelength fixed filters 61-1 to 61-M and the signal selection units 82-1 to 82-MN to distribute a unified type of control signal to each component, or may add different types of information to the control signals to be distributed to different components.

The signal generation units 21-1 to 21-MN transmit the first data signals as electrical packet signals to the corresponding time-division multiplexing units 22-1 to 22-M at the transmission timings determined by the control unit 100.

Each of the time-division multiplexing units 22-1 to 22-M multiplexes the N electrical packet signals acquired from the N signal generation units 21 of the same optical transmission device 20 based on the routing information included in the first control signal acquired from the control unit 100, and outputs the resultant signal to the optical transmitter 23 of the same optical transmission device 20.

The optical transmitters 23-1 to 23-M convert the electrical packet signals acquired from the corresponding signal generation units 21-1 to 21-MN into optical packet signals. In the present embodiment, the optical transmitters 23-1 to 23-M can generate optical signals set at the designated output wavelength λ, specifically, one of the output wavelengths λ1 to λM, based on the routing information included in the first control information acquired from the control unit 100. The optical transmitters 23-1 to 23-M transmit the optical packet signals generated through conversion to the optical coupler 30. Specifically, the optical transmitter 23-1 converts the electrical packet signal into an optical packet signal having the output wavelength λ1, the optical transmitter 23-2 converts the electrical packet signal into an optical packet signal having the output wavelength λ2, and the optical transmitter 23-M converts the electrical packet signal into an optical packet signal having the output wavelength λM. Note that in the example of FIG. 14, the signal generation unit 21, the time-division multiplexing unit 22, and the optical transmitter 23 are illustrated as separate blocks in the optical transmission device 20. However, the functions of the signal generation unit 21 and the time-division multiplexing unit 22 may be incorporated in the optical transmitter 23.

The subsequent operations of the optical coupler 30, the optical coupler 50, the wavelength fixed filters 61-1 to 61-M, the optical couplers 70-1 to 70-M, the optical receivers 81-1 to 81-MN, and the signal selection units 82-1 to 82-MN are similar to those in the fifth embodiment.

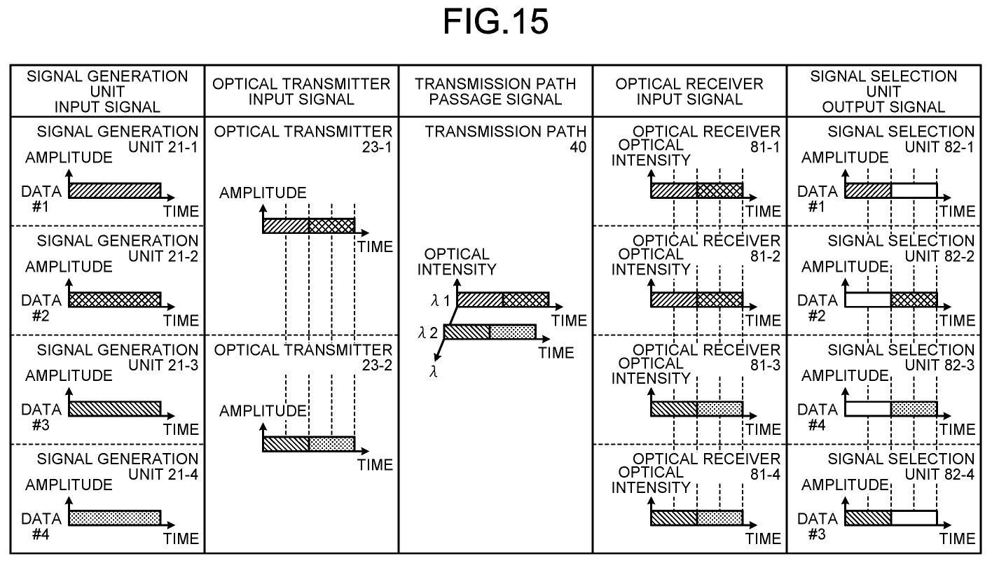

FIG. 15 is a diagram illustrating an example of signals transmitted in the optical communication system 200 according to the sixth embodiment. FIG. 15 also depicts the procedure for the operation of the optical communication system 200 according to the sixth embodiment. FIG. 15 illustrates, as an example in the case of M=2 and N=2, first data signals that are input signals to the signal generation units 21-1 to 21-4, packets as electrical signals that are input signals to the optical transmitters 23-1 and 23-2, optical transmission signals that are passage signals through the transmission path 40, optical transmission signals that are input signals to the optical receivers 81-1 to 81-4, and second data signals that are output signals from the signal selection units 82-1 to 82-4. As illustrated in FIG. 15, the first data signal of data #1 is input to the signal generation unit 21-1, the first data signal of data #2 is input to the signal generation unit 21-2, the first data signal of data #3 is input to the signal generation unit 21-3, and the first data signal of data #4 is input to the signal generation unit 21-4.

The signal generation units 21-1 to 21-4 equalize the bit rates of the electrical packet signals to be output from the respective signal generation units 21 based on the reference clock included in the first control signal acquired from the control unit 100. In addition, based on the transmission timing signal included in the first control signal acquired from the control unit 100, the signal generation units 21-1 to 21-4 determine the transmission timings of the electrical packet signals such that the signal generation units 21 of the same optical transmission devices 20 do not transmit the electrical packet signals in the same time slot.

Specifically, in a case where all the signal generation units 21-1 to 21-4 have transmission requests for packet signals of the same size as in FIG. 15, the signal generation units 21-1 and 21-3 transmit the electrical packet signals, and the other signal generation units 21-2 and 21-4 do not transmit the electrical packet signals during the first time slot 1. During the second time slot 2, the signal generation units 21-2 and 21-4 transmit the electrical packet signals, and the other signal generation units 21-1 and 21-3 do not transmit the electrical packet signals. In this manner, the signal generation units 21-1 to 21-4 adjust the transmission timings of the electrical packet signals based on the transmission timing signal included in the first control signal acquired from the control unit 100.

The time-division multiplexing unit 22-1 multiplexes the electrical packet signals acquired from the signal generation units 21-1 and 21-2 of the same optical transmission device 20-1 based on the routing information included in the first control signal acquired from the control unit 100, and outputs the resultant signal to the optical transmitter 23-1 of the same optical transmission device 20-1. The time-division multiplexing unit 22-2 multiplexes the electrical packet signals acquired from the signal generation units 21-3 and 21-4 of the same optical transmission device 20-2 based on the routing information included in the first control signal acquired from the control unit 100, and outputs the resultant signal to the optical transmitter 23-2 of the same optical transmission device 20-2.

The subsequent operations of the optical transmitters 23-1 and 23-2, the optical coupler 30, the optical coupler 50, the wavelength fixed filters 61-1 and 61-2, the optical couplers 70-1 and 70-2, the optical receivers 81-1 to 81-4, and the signal selection units 82-1 to 82-4 are similar to those in the fifth embodiment.

As described above, the optical transmission devices 20-1 to 20-M include the plurality of signal generation units 21, the plurality of time-division multiplexing units 22, and the plurality of optical transmitters 23. The plurality of signal generation units 21 each buffer the first data signal, allocate a time slot based on the first control signal, determine a bit rate, and generate an electrical packet signal. The time-division multiplexing unit 22 multiplexes a plurality of electrical packet signals. The optical transmitter 23 sets, based on the routing information included in the first control signal, the wavelength of the wavelength variable light source for use in converting the electrical packet signal into an optical packet signal, and converts the electrical packet signal generated through multiplexing by the time-division multiplexing unit 22 into an optical packet signal using a different wavelength for each of the plurality of optical transmission devices 20. In addition, the plurality of optical reception devices 80 select signals of designated time slots from the electrical transmission signals based on the second control signal, and output the signals as second data signals.

As described above, according to the present embodiment, the optical communication system 200 controls the transmission timing for the signal generation unit 21 of each optical transmission device 20 using the TDM method and the WDM method, that is, the TWDM method, so that the matrix switch connection can be configured just with the passive components, namely the optical couplers 30, 50, and 70, without using an optical switch in the optical domain, which can improve the reliability. In addition, the optical communication system 200, which does not use an optical switch, can achieve low power consumption, space saving, weight reduction, and cost reduction.

On the other hand, the optical communication system 200 according to the sixth embodiment requires about several 10 us for wavelength switching of the variable wavelength light source provided in the optical transmitter 23 of the optical transmission device 20, and thus requires a switching speed equivalent to that of an optical switch. However, in the optical communication system 200 according to the sixth embodiment, the compression rate of data is only ⅟(number of wavelengths), so that the load of system processing can be reduced.

In addition, as compared with the optical communication system 200 according to the fifth embodiment, the optical communication system 200 according to the sixth embodiment can reduce the number of optical transmitters 23 given that the total number of input ports is fixed, and thus can achieve low power consumption, space saving, weight reduction, and cost reduction.

The optical communication system according to the present disclosure can achieve the effect of improving reliability.

The configurations described in the above-mentioned embodiments indicate examples. The embodiments can be combined with another well-known technique and with each other, and some of the configurations can be omitted or changed in a range not departing from the gist.

What is claimed is:

1. An optical communication system comprising:
a plurality of optical transmission devices to each convert a first data signal that is an electrical signal into an optical packet signal, and transmit the optical packet signal;
a first optical coupler to couple a plurality of the optical packet signals into an optical transmission signal, and output the optical transmission signal to a transmission path;
a second optical coupler to branch the optical transmission signal generated through coupling by the first optical coupler and acquired via the transmission path into a plurality of the optical transmission signals having same information, and output the optical transmission signals;
a plurality of optical reception devices to each receive one of the optical transmission signals generated through branching by the second optical coupler, convert the optical transmission signal into a second data signal that is an electrical signal, and output the second data signal; and
control circuitry to control operation of the plurality of optical transmission devices and the plurality of optical reception devices, wherein
the optical transmission devices allocate a communication resource based on a first control signal acquired from the control circuitry to avoid collision with the optical packet signal transmitted from another optical transmission device, and transmit the optical packet signal, and
the optical reception devices convert the optical transmission signal into an electrical transmission signal, select a designated signal portion from the electrical transmission signal based on a second control signal acquired from the control circuitry, and output the designated signal portion as the second data signal.

2. The optical communication system according to claim 1, wherein
the control circuitry generates a reference clock that defines a forwarding rate for transmission/reception of the optical packet signals, determines a communication resource allocation on the transmission path based on a communication request, generates routing information indicating which optical reception device outputs as the second data signal the first data signal acquired by which optical transmission device, distributes the reference clock, the communication resource allocation, and the routing information to the optical transmission devices as the first control signal, and distributes the communication resource allocation and the routing information to the optical reception devices as the second control signal.

3. The optical communication system according to claim 1, wherein
the optical transmission devices include:
signal generation circuitry to buffer the first data signal, allocate a communication resource allocation based on the first control signal, determine a bit rate, and generate an electrical packet signal; and
an optical transmitter to convert the electrical packet signal into the optical packet signal.

4. The optical communication system according to claim 1, wherein
the optical reception devices include:
an optical receiver to convert the optical transmission signal into an electrical transmission signal; and
signal selection circuitry to select a signal of a designated time slot from the electrical transmission signal based on the second control signal, and output the signal as the second data signal.

5. The optical communication system according to claim 1, wherein
time slots are provided as the communication resource,
the plurality of optical transmission devices allocate time slots based on the first control signal to avoid collision with the optical packet signal transmitted from another optical transmission device, and transmit the optical packet signal, and
the plurality of optical reception devices select a signal of a designated time slot from the electrical transmission signal based on the second control signal, and output the signal as the second data signal.

6. The optical communication system according to claim 1, wherein
time slots are provided as the communication resource,
the optical communication system further includes:
a plurality of the first optical couplers;
a plurality of the second optical couplers;
a plurality of signal dividing circuits to each divide the first data signal based on the first control signal, and output the first data signal divided to two or more of the optical transmission devices connected to different ones of the first optical couplers; and
a plurality of signal combining circuits to each combine, based on the second control signal, the second data signals output from two or more of the optical reception devices connected to different ones of the second optical couplers,
the plurality of optical transmission devices acquire the first data signal from the signal dividing circuits, allocate time slots based on the first control signal to avoid collision with the optical packet signal transmitted from another optical transmission device connected to the same first optical coupler, and transmit the optical packet signal, and
the plurality of optical reception devices select a signal of a designated time slot from the electrical transmission signal based on the second control signal, and output the signal as the second data signal to the signal combining circuits.

7. The optical communication system according to claim 1, wherein
time slots and wavelengths are provided as the communication resource,
the optical communication system further includes:
a plurality of wavelength variable filters to each set a transmission wavelength for the optical transmission signals based on the second control signal; and
third optical couplers to each branch the optical transmission signal acquired from the wavelength variable filters into a plurality of the optical transmission signals having same information, and output the optical transmission signals,
the plurality of optical transmission devices allocate time slots based on the first control signal to avoid collision with the optical packet signal transmitted from another optical transmission device that uses a same wavelength, and transmit the optical packet signal, and
the plurality of optical reception devices select a signal of a designated time slot from the electrical transmission signal based on the second control signal, and output the signal as the second data signal.

8. The optical communication system according to claim 1, wherein
time slots and wavelengths are provided as the communication resource,
the optical communication system further includes:
a plurality of wavelength variable filters to each set a transmission wavelength for the optical transmission signals based on the second control signal; and
third optical couplers to each branch the optical transmission signal output from the wavelength variable filters into a plurality of the optical transmission signals having same information, and output the optical transmission signals,
the plurality of optical transmission devices include:
a plurality of signal generation circuits to each buffer the first data signal, allocate a time slot based on the first control signal, determine a bit rate, and generate the electrical packet signal;
a time-division multiplexer to multiplex a plurality of the electrical packet signals; and
an optical transmitter to convert the electrical packet signal generated through multiplexing by the time-division multiplexer into the optical packet signal using a different wavelength for each of the plurality of optical transmission devices, and
the plurality of optical reception devices select a signal of a designated time slot from the electrical transmission signal based on the second control signal, and output the signal as the second data signal.

9. The optical communication system according to claim 1, wherein
time slots and wavelengths are provided as the communication resource,
the optical communication system further includes:
a plurality of wavelength fixed filters to each allow the optical transmission signals of a set transmission wavelength to pass through; and
third optical couplers to each branch the optical transmission signal output from the wavelength fixed filters into a plurality of the optical transmission signals having same information, and output the optical transmission signals,
the plurality of optical transmission devices set, based on the first control signal, a wavelength of a wavelength variable light source for use in converting the first data signal into the optical packet signal, allocate time slots to avoid collision with the optical packet signal transmitted from another optical transmission device that uses a same wavelength, and transmit the optical packet signal, and
the plurality of optical reception devices select a signal of a designated time slot from the electrical transmission signal based on the second control signal, and output the signal as the second data signal.

10. The optical communication system according to claim 1, wherein
time slots and wavelengths are provided as the communication resource,
the optical communication system further includes:
a plurality of wavelength fixed filters to each allow the optical transmission signals of a set transmission wavelength to pass through; and
third optical couplers to each branch the optical transmission signal output from the wavelength fixed filters into a plurality of the optical transmission signals having same information, and output the optical transmission signals,
the plurality of optical transmission devices include:
a plurality of signal generation circuits to each buffer the first data signal, allocate a time slot based on the first control signal, determine a bit rate, and generate the electrical packet signal;
a time-division multiplexer to multiplex a plurality of the electrical packet signals; and
an optical transmitter to set, based on the first control signal, a wavelength of a wavelength variable light source for use in converting the electrical packet signal into the optical packet signal, and convert the electrical packet signal generated through multiplexing by the time-division multiplexer into the optical packet signal using a different wavelength for each of the plurality of optical transmission devices, and
the plurality of optical reception devices select a signal of a designated time slot from the electrical transmission signal based on the second control signal, and output the signal as the second data signal.

11. A control circuit for controlling an optical communication system,
the optical communication system comprising:
a plurality of optical transmission devices to each convert a first data signal that is an electrical signal into an optical packet signal, and transmit the optical packet signal;
a first optical coupler to couple a plurality of the optical packet signals into an optical transmission signal, and output the optical transmission signal to a transmission path;
a second optical coupler to branch the optical transmission signal generated through coupling by the first optical coupler and acquired via the transmission path into a plurality of the optical transmission signals having same information, and output the optical transmission signals;
a plurality of optical reception devices to each receive one of the optical transmission signals generated through branching by the second optical coupler, convert the optical transmission signal into a second data signal that is an electrical signal, and output the second data signal; and
control circuitry to control operation of the plurality of optical transmission devices and the plurality of optical reception devices, wherein
the control circuit causes the optical transmission devices to allocate a communication resource based on a first control signal acquired from the control circuitry to avoid collision with the optical packet signal transmitted from another optical transmission device, and transmit the optical packet signal, and
the control circuit causes the optical reception devices to convert the optical transmission signal into an electrical transmission signal, select a designated signal portion from the electrical transmission signal based on a second control signal acquired from the control circuitry, and output the designated signal portion as the second data signal.

12. A storage medium storing a program for controlling an optical communication system,
the optical communication system comprising:
a plurality of optical transmission devices to each convert a first data signal that is an electrical signal into an optical packet signal, and transmit the optical packet signal;
a first optical coupler to couple a plurality of the optical packet signals into an optical transmission signal, and output the optical transmission signal to a transmission path;
a second optical coupler to branch the optical transmission signal generated through coupling by the first optical coupler and acquired via the transmission path into a plurality of the optical transmission signals having same information, and output the optical transmission signals;
a plurality of optical reception devices to each receive one of the optical transmission signals generated through branching by the second optical coupler, convert the optical transmission signal into a second data signal that is an electrical signal, and output the second data signal; and
control circuitry to control operation of the plurality of optical transmission devices and the plurality of optical reception devices, wherein
the program causes the optical transmission devices to allocate a communication resource based on a first control signal acquired from the control circuitry to avoid collision with the optical packet signal transmitted from another optical transmission device, and transmit the optical packet signal, and
the program causes the optical reception devices to convert the optical transmission signal into an electrical transmission signal, select a designated signal portion from the electrical transmission signal based on a second control signal acquired from the control circuitry, and output the designated signal portion as the second data signal.

13. An optical communication method comprising:
converting a first data signal that is an electrical signal into an optical packet signal, and transmitting the optical packet signal based on control of control circuitry, performed by each of a plurality of optical transmission devices;
coupling a plurality of the optical packet signals into an optical transmission signal, and outputting the optical transmission signal to a transmission path;
branching the optical transmission signal generated through coupling by the first optical coupler and acquired via the transmission path into a plurality of the optical transmission signals having same information, and outputting the optical transmission signals; and
receiving one of the optical transmission signals generated through branching by the second optical coupler, converting the optical transmission signal into a second data signal that is an electrical signal, and outputting the second data signal based on control of the control circuitry, performed by each of a plurality of optical reception devices, wherein
in the converting, the optical transmission devices allocate a communication resource based on a first control signal acquired from the control circuitry to avoid collision with the optical packet signal transmitted from another optical transmission device, and transmit the optical packet signal, and
in the receiving, the optical reception devices convert the optical transmission signal into an electrical transmission signal, select a designated signal portion from the electrical transmission signal based on a second control signal acquired from the control circuitry, and output the designated signal portion as the second data signal.
